(19) United States
(12) Patent Application Publication
(10) Pub. No.: US 2018/0352108 A1
(43) Pub. Date: Dec. 6, 2018

(54) IMAGE FORMING APPARATUS AND CONTROL METHOD

(71) Applicant: Konica Minolta, Inc., Tokyo (JP)

(72) Inventors: Yoshiteru KAWAKAMI, Tokyo (JP); Yasuo SHIOKAWA, Tokyo (JP); Takahiro OKUBO, Yokohama-shi (JP)

(21) Appl. No.: 15/987,294

(22) Filed: May 23, 2018

(30) Foreign Application Priority Data
May 31, 2017 (JP) 2017-107579
May 31, 2017 (JP) 2017-107586
May 31, 2017 (JP) 2017-107626

(51) Int. Cl. H04N 1/12; H04N 1/00

(52) U.S. Cl. CPC H04N 1/1215; H04N 1/00602

(57) ABSTRACT

An image forming apparatus includes a transfer unit, a sway roller pair constituted of a pair of rollers, a hardware processor and an image reader. The transfer unit transfers an image onto paper being conveyed to an image transfer position where the transfer unit transfers the image onto the paper. The sway roller pair conveys the paper to the transfer unit, the paper being conveyed to the sway roller pair. The hardware processor makes the sway roller pair sway based on predetermined sway control information. The image reader reads the paper onto which the image has been transferred by the paper having passed through the transfer unit. The hardware processor corrects the sway control information based on a reading result of the reading performed by the image reader.

### BACKGROUND

### 1. Technological Field

The present invention relates to an image forming apparatus and a control method.

### 2. Description of the Related Art

In recent years, multifunctional image forming apparatuses having functions of a printer, a scanner, a copier, a facsimile and so forth have been widely used. In this type of image forming apparatus, at the time of image forming, paper is conveyed from a paper feeder or a reverse path to a transfer unit. At the time, due to a mechanical factor of the apparatus or the like, the paper may head toward one side in a direction (hereinafter “paper width direction”) orthogonal to a paper conveying direction in which the paper is conveyed. If printing is performed in this state, in which the paper heads toward one side in the paper width direction (hereinafter “paper one-side heading”), the position of an image to be formed on the paper deviates from its original proper position, which is a problem.

In order to perform accurate positioning of an image on paper taking the paper one-side heading into account, rollers for registration (hereinafter “registration roller pair”) hold and sandwich paper and sway the paper in the paper width direction, thereby correcting the paper one-side heading. For example, there is disclosed in Japanese Patent Application Publication No. 2013-91563 an image forming apparatus having: a registration roller pair on the upstream side of an image forming position; and a line sensor on the downstream side of the registration roller pair but on the upstream side of a pair of rollers for secondary transfer (hereinafter “secondary transfer roller pair”), wherein the registration roller pair sways paper in the paper width direction on the basis of the amount of the paper one-side heading detected by the line sensor, thereby correcting the paper one-side heading.

In such a conventional technology, before the top of paper reaches the secondary transfer roller pair, the registration roller pair sways, thereby adjusting the position of a side edge of the paper. However, only the sway before paper reaches the secondary transfer roller pair still causes sub-scanning curving, which is a phenomenon of paper being curved in the paper conveying direction (i.e. a sub-scanning direction) from somewhere on the paper by misalignment of the registration roller pair, the secondary transfer roller pair and a pair of rollers for fixing (hereinafter may be called “fixing roller pair”) or by difference between roller diameters of the front/near side and the back/far side of each roller when the image forming apparatus is viewed from the front. Skew correction, which corrects a skew(s) of paper by making the paper abut the registration roller pair, corrects a skew of the top of paper, but does not perform such correction on the bottom of the paper. Hence, a contortion(s) remains somewhere between the top and the bottom of the paper, so that sub-scanning curving occurs. (Refer to FIG. 16.) This tends to occur in long paper in particular, and sub-scanning curving therein is significant. If printing is performed in the state in which sub-scanning curving occurs, the position of an image to be formed (i.e. the image forming position) on paper deviates at a point(s) of the paper.

### SUMMARY

Objects of the present invention include suppressing deviation of the position of an image (image position) on paper caused by sub-scanning curving.

In order to achieve at least one of the abovementioned objects, according to an aspect of the present invention, there is provided an image forming apparatus including: a transfer unit that transfers an image onto paper being conveyed to an image transfer position where the transfer unit transfers the image onto the paper; a sway roller pair constituted of a pair of rollers that conveys the paper to the transfer unit, the paper being conveyed to the sway roller pair; a hardware processor that makes the sway roller pair sway based on predetermined sway control information; and an image reader that reads the paper onto which the image has been transferred by the paper having passed through the transfer unit, wherein the hardware processor corrects the sway control information based on a reading result of the reading performed by the image reader.

Further, according to another aspect of the present invention, there is provided a sway roller control method for an image forming apparatus including a sway roller pair constituted of a pair of rollers that conveys, to a transfer unit, paper being conveyed to the sway roller pair, including—making the sway roller pair sway based on predetermined sway control information; causing an image reader to read the paper onto which an image has been transferred by the paper having passed through the transfer unit; and correcting the sway control information based on a reading result of the reading performed by the image reader.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 schematically shows configuration of an image forming apparatus according to first and second embodiments of the present invention;

FIG. 2 is an explanatory diagram showing a sway process of paper by a registration roller pair according to the first and second embodiments;

FIG. 3 is a block diagram schematically showing configuration of a control system of the image forming apparatus shown in FIG. 1;

FIG. 4 shows an example of how data are stored in a second sway control table;

FIG. 5 is a flowchart showing a sway control process A that is performed in the first embodiment by a controller shown in FIG. 3;

FIG. 6 is a flowchart showing a sway control process B that is performed in the second embodiment by the controller shown in FIG. 3;

FIG. 7 schematically shows configuration of an image forming apparatus according to third to sixth embodiments of the present invention;

FIG. 8 is a block diagram schematically showing configuration of a control system of the image forming apparatus according to the third and fourth embodiments;

FIG. 9 is an explanatory diagram showing a sway process of paper by a registration roller pair according to the third to sixth embodiments;

FIG. 10 is a flowchart showing a sway control process C that is performed in the third embodiment by a controller shown in FIG. 8;

FIG. 11 is a flowchart showing a sway control process D that is performed in the fourth embodiment by the controller shown in FIG. 8;

FIG. 12 is a block diagram schematically showing configuration of a control system of the image forming apparatus according to the fifth and sixth embodiments;

FIG. 13 shows an example of how data are stored in a sway control table;

FIG. 14 is a flowchart showing a sway control process E that is performed in the fifth embodiment by a controller shown in FIG. 12;

FIG. 15 is a flowchart showing a sway control process F that is performed in the sixth embodiment by the controller shown in FIG. 12; and

FIG. 16 shows an example of sub-scanning curving.

### DETAILED DESCRIPTION OF EMBODIMENTS

Hereinafter, one or more embodiments of the present invention will be described in detail with reference to the drawings. However, the scope of the invention is not limited to the disclosed embodiments or illustrated examples.

### First Embodiment

### [Configuration of Image Forming Apparatus 100A]

First, configuration of an image forming apparatus 100A according to a first embodiment is described.

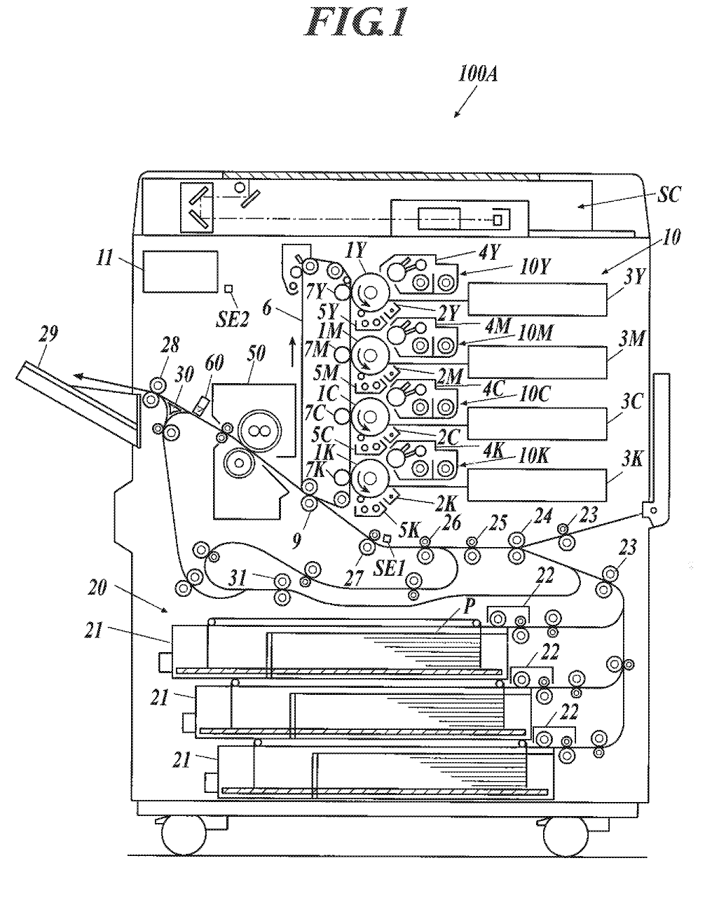

FIG. 1 schematically shows the image forming apparatus 100A according to this embodiment. This image forming apparatus 100A is an electrophotographic image forming apparatus 100A, such as a copier, and, what is called, a tandem color image forming apparatus having photoreceptors arranged in a vertical direction in such a way as to face one intermediate transfer belt, thereby forming full-color images.

The image forming apparatus 100A includes a document scanner SC, an image former 10, a fixing device 50, an image reader 60 and a controller 11 as main components, and these components are housed in one casing.

The document scanner SC scans and thereby exposes images of documents with an optical system of a scanning exposure device, and reads the reflected light with a line image sensor, thereby obtaining image signals. The image signals are input to the controller 11 as image data after being subjected to image processing, such as A/D conversion, shading correction and compression. The image data input to the controller 11 are not limited to those read by the document scanner SC and may be image data received by a communication unit 13 from a personal computer or another image forming apparatus connected to the image forming apparatus 100A.

The image former 10 includes four image forming units (image writers) 10Y, 10M, 10C, 10K, an intermediate transfer belt 6, and a secondary transfer roller pair 9. The image forming units 10Y, 10M, 10C, 10K form yellow (Y) images, magenta (M) images, cyan (C) images and black (K) images, respectively.

The image forming unit 10Y includes: a photoconductive drum 1Y; and a charger 2Y, an optical writer 3Y, a developing device 4Y and a drum cleaner 5Y arranged around the photoconductive drum 1Y. Similarly, the image forming units 10M, 10C, 10K include: photoconductive drums 1M, 1C, 1K; and chargers 2M, 2C, 2K, optical writers 3M, 3C, 3K, developing devices 4M, 4C, 4K and drum cleaners 5M, 5C, 5K arranged around their respective photoconductive drums 1M, 1C, 1K.

The chargers 2Y, 2M, 2C, 2K charge surfaces of the photoconductive drums 1Y, 1M, 1C, 1K uniformly, and the optical writers 3Y, 3M, 3C, 3K form latent images on the photoconductive drums 1Y, 1M, 1C, 1K by scanning exposure. The developing devices 4Y, 4M, 4C, 4K visualize the latent images on the photoconductive drums 1Y, 1M, 1C, 1K by developing the latent images with toners, thereby forming toner images of predetermined colors corresponding to yellow, magenta, cyan and black on the photoconductive drums 1Y, 1M, 1C, 1K. The toner images formed on the photoconductive drums 1Y, 1M, 1C, 1K are successively transferred by primary transfer rollers 7Y, 7M, 7C, 7K onto a predetermined point on the rotating intermediate transfer belt 6.

The toner image of the colors transferred onto the intermediate transfer belt 6 is transferred by the secondary transfer roller pair 9 onto the paper P conveyed thereto by the below-described paper conveyor 20 at a predetermined timing The secondary transfer roller pair 9 is a pressure contact member that forms a nip part (hereinafter “transfer nip part”) by being arranged to press and contact the intermediate transfer belt 6.

The paper conveyor 20 conveys the paper P along a paper conveyance path. The paper P is housed in a paper feeding tray(s) 21. The paper P housed in the paper feeding tray 21 is taken by a paper feeder 22 to be sent out to the conveyance path. Alternatively, the paper P is housed in a paper feeding tray(s) of a paper feeding apparatus (not shown) connected to the image forming apparatus 100A. The paper P which the paper feeding apparatus has is supplied to the image forming apparatus 100A and sent out to the conveyance path.

On this conveyance path, on the upstream side of the transfer nip part, conveying units that convey the paper P are arranged. Each conveying unit is constituted of a pair of rollers that press against and contact with each other, and at least one of the rollers is rotationally driven through a drive mechanism that includes an electric motor as a main component, thereby conveying the paper P. Each pair of rollers constituting each conveying unit is configured to switch its inter-roller state between a press-and-contact state and a separate state.

In this embodiment, from the upstream side to the downstream side of the conveyance path, intermediate conveying roller pairs 23 to 25, a loop roller pair 26 and a registration roller pair 27 are arranged as the conveying units. Each conveying unit is not limited to a pair of rollers as described above, and can be any pair of rotational members of a wide range. For example, a conveying unit may be a combination of belts or a combination of a belt and a roller.

On this conveyance path, sheets of the paper P fed from the paper feeding tray 21 or the paper feeding tray of the paper feeding apparatus are successively conveyed by the intermediate conveying roller pairs 23 to 25 and the loop roller pair 26 arranged from the upstream side to the downstream side and thereby travel on the conveyance path. When the top of (a sheet of) the paper P conveyed by the intermediate conveying roller pairs 23 to 25 and the loop roller pair 26 approaches the registration roller pair 27, the paper P abuts the registration roller pair 27 that is in a rotation-suspended state, and a loop (warp) is formed on the paper P by the loop roller pair 26 still rotating for a predetermined time. By action of this loop forming, a skew of the top of the paper P is corrected (skew correction).

When the registration roller pair 27 restarts rotating at a predetermined timing such that the position of the paper P can be proper for the toner image held by the intermediate transfer belt 6, the intermediate conveying roller pairs 23 to 25 and the loop roller pair 26 switch from the press-and-contact state to the separate state. That is, when the intermediate conveying roller pairs 23 to 25 and the loop roller pair 26 switch to the separate state, the paper P is conveyed by the registration roller pair 27 only. The registration roller pair 27 performs the below-described sway process as a sway roller pair constituted of a pair of rollers while conveying the paper P, and conveys the paper P to the transfer nip part constituted of the intermediate transfer belt 6 as an image holder and the secondary transfer roller pair 9 as a transfer unit.

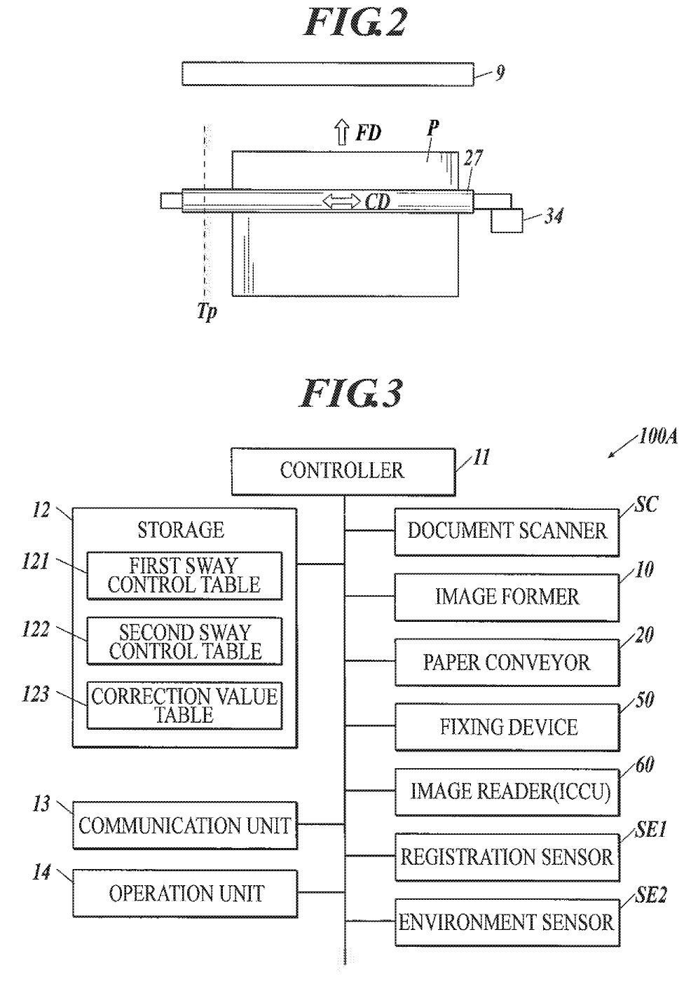

FIG. 2 is an explanatory diagram showing the sway process of the paper P by the registration roller pair 27. The registration roller pair 27 is configured to sway in a paper width direction CD (direction orthogonal to a paper conveying direction (sub-scanning direction) FD). The registration roller pair 27 is connected to a drive mechanism 34 having an electric motor as a main component, and can move in the paper width direction CD by being driven by the drive mechanism 34, taking a predetermined home position as a start position.

The registration roller pair 27 moves along the paper width direction CD during a passing period during which the paper P passes through the registration roller pair 27, thereby moving the paper P, which is being conveyed, along the paper width direction CD (sway process). Thus, the registration roller pair 27 adjusts the position of the paper P in the paper width direction CD such that the position of the paper P agrees with the position of the toner image to be transferred onto the paper P. Here, a point in the paper width direction CD on which a side edge of the paper P should move is referred to as a target position Tp. This target position Tp indicates the position that is expected to make a positional relationship between the paper P and the toner image in the paper width direction CD optimum (e.g. to match the center in the width direction of the paper P with the center in the width direction of the toner image) if the side edge of the paper P moves thereon. The registration roller pair 27 adjusts the position of the paper P in the paper width direction CD such that the side edge of the paper P is on the target position Tp. The position of the toner image which makes the positional relationship between the paper P and the toner image optimum is referred to as an image's optimum position.

Over the conveyance path, a registration sensor SE1 is provided. On the basis of a detection result(s) obtained by the registration sensor SE1, the controller 11 controls operation of the registration roller pair 27.

The registration sensor SE1 is arranged between the registration roller pair 27 and the loop roller pair 26 over the conveyance path, and detects arrival of the top of the paper P at a detection position of the registration sensor SE1 (a position a predetermined distance before the registration roller pair 27). This detection result by the registration sensor SE1 is used for detection of a rotation start timing of the registration roller pair 27 or the like.

Referring back to FIG. 1, the fixing device 50 is a device that performs a fixing process on the paper P onto which the toner image has been transferred, namely, the paper P sent out from the transfer nip part, and includes, for example, a pair of fixing members (e.g. a pair of rollers) and a heater that heats one or both of the fixing members. In the process of conveyance of the paper P, the fixing device 50 fixes the toner image to the paper P by pressure of the fixing members and action of heat which the fixing members has.

The paper P subjected to the fixing process by the fixing device 50 is read by the image reader (ICCU) 60, and then ejected by a pair of rollers for paper ejection (hereinafter “paper ejection roller pair”) 28 onto a paper receiving tray 29 attached to an outer lateral surface of the casing. If an image(s) is also formed on the back side of the paper P, the paper P with the image(s) formed on the front side is read by the image reader 60, and then conveyed by a switching gate 30 to a pair of rollers for reverse (hereinafter “reverse roller pair) 31 provided on the lower side of the image forming apparatus 100A. The rollers of the reverse roller pair 31 sandwich and hold the bottom of the paper P conveyed thereto, and then reverse the paper P by sending the paper P backward, thereby sending out the reversed paper P to a paper re-feeding conveyance path. The paper P sent out to this paper re-feeding conveyance path is conveyed by a plurality of conveying units for paper re-feeding, thereby being returned to the transfer nip part via the registration roller pair 27. The paper ejection roller pair 28, the switching gate 30, the reverse roller pair 31 and the conveying units for paper re-feeding are also included in the above-described paper conveyor 20.

The image reader 60 includes, for example, a linear image sensor (e.g. a CCD line sensor, etc.), an optical system and a light source, and reads the paper P on which the toner image has been transferred, and outputs the obtained read image to the controller 11. In this embodiment, the image reader 60 is one that can measure colors of the toner image on the paper P, but not particularly limited as far as it can recognize the region of the paper P and the region of the toner image. Further, in this embodiment, the image reader 60 is arranged on the downstream side of the fixing device 50 but in front of where the conveyance path is switched by the switching gate 30. However, the arrangement position of the image reader 60 is not particularly limited as far as it is on the downstream side of the secondary transfer roller pair 9 and where the image reader 60 can read both sides of the paper P (may read one side for each time). Needless to say, an optional apparatus as the image reader 60 may be arranged on the downstream side of the image forming apparatus 100A.

FIG. 3 is a block diagram schematically showing configuration of a control system of the image forming apparatus 100A according to this embodiment.

As shown in FIG. 3, the controller 11 is connected to a storage 12, the communication unit 13, an operation unit 14, the document scanner SC, the image former 10, the paper conveyor 20, the fixing device 50, the image reader 60, the registration sensor SE1 and an environment sensor SE2. The controller 11 includes a CPU (Central Processing Unit, hardware processor) and a RAM (Random Access Memory). The CPU of the controller 11 reads system programs and various process programs including a program to perform a sway control process A stored in the storage 12, opens the read programs on the RAM, and performs centralized control of operations of the components of the image forming apparatus 100A in accordance with the opened programs. For example, when a job execution instruction is input through the operation unit 14, the controller 11 executes a job and performs control to form a toner image(s) on the paper P on the basis of image data input through the document scanner SC or the communication unit 13. When the job execution instruction is input through the operation unit 14, the controller 11 also performs a sway control process A described below so as to perform sway control of the registration roller pair 27 that is in execution of the job and correct sway control information.

The storage 12 is constituted of a nonvolatile semiconductor memory, an HDD (Hard Disk Drive) and/or the like, and stores the various programs that are executed by the controller 11, and parameters, data and so forth needed by the components of the image forming apparatus 100A.

For example, the storage 12 stores a first sway control table 121, a second sway control table 122 and a correction value table 123.

The first sway control table 121 is a table where the (pieces of) sway control information (here, as examples, the target position Tp for the paper P and a sway speed) to control sway of the registration roller pair 27 before the paper P enters the secondary transfer roller pair 9 (before the paper P arrives at the transfer nip part) is stored.

The sway control information to form a toner image(s) at the image's optimum position without generating noise or the like differs depending on a condition(s) relevant to paper conveyance (hereinafter “paper conveyance condition”), such as a paper type (basis weight, size, paper quality, etc.) of the paper P, an environment (e.g. temperature and humidity), an image-formed side (front side/back side) of the paper P (hereinafter “print side”) and/or a paper feeding tray. That is, in order to write a toner image(s) at the image's optimum position on the paper P with high accuracy, it is preferable to store, in the first sway control table 121, the sway control information for each paper type, each environment, each print side, each paper feeding tray or each combination of these.

The second sway control table 122 is a table where the (pieces of) sway control information (here, as examples, the target position Tp for the paper P, a sway direction (+, −) and the sway speed) to control the sway of the registration roller pair 27 after the paper P enters the secondary transfer roller pair 9 is stored.

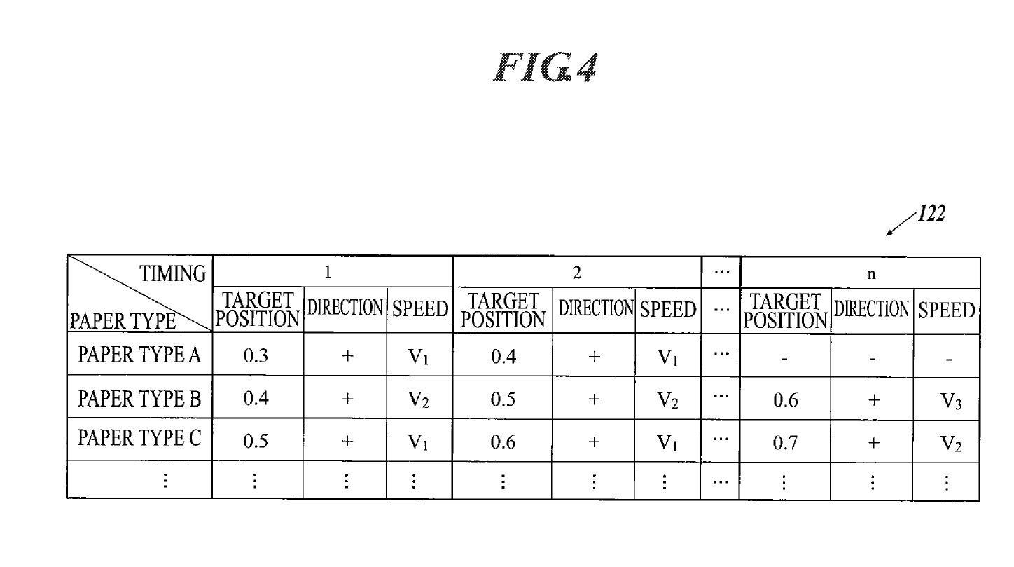

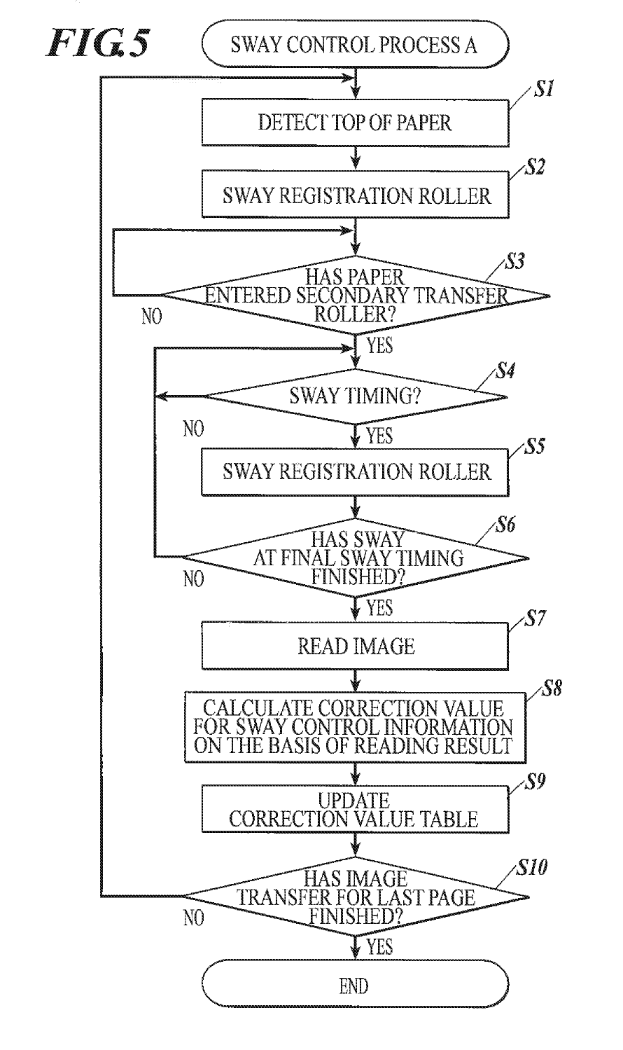

FIG. 4 shows an example of the second sway control table 122. In this embodiment, after the paper P enters the secondary transfer roller pair 9, the registration roller pair 27 is controlled to sway at predetermined multiple timings (hereinafter “sway timings”), and in the second sway control table 122, the sway control information used at each of the sway timings (timings 1 to n) is stored. As described above, in order to write a toner image(s) at the image's optimum position on the paper P with high accuracy, it is preferable to store, in the second sway control table 122, the sway control information used at each of the sway timings (timings 1 to n) for each paper type, each environment, each print side, each paper feeding tray or each combination of these (i.e. for the paper conveyance condition). FIG. 4 shows, as an example, the second sway control table 122 where the sway control information used at each of the sway timings (timings 1 to n) for each paper type is stored.

The correction value table 123 is a table where correction values to correct the sway control information in the first sway control table 121 and the second sway control table 122 are stored.

Even if the side edge of the paper P is adjusted to be on the target position Tp, the toner image may not be formed at the image's optimum position because of sub-scanning curving described above or the like. In addition, its deviation amount differs depending on the paper conveyance condition, such as the paper type of the paper P, the environment, the print side and/or the paper feeding tray of the paper P. Hence, in the correction value table 123, the correction values for the sway control information in the first sway control table 121 and the second sway control table 122 for the paper conveyance condition, namely, for each paper type, each environment, each print side, each paper feeding tray or each combination of these, are stored.

In this embodiment, the sway control information used for the sway control of the registration roller pair 27 is information obtained by correcting the sway control information stored in the first sway control table 121 and the second sway control table 122 with the correction values stored in the correction value table 123.

The communication unit 13 includes various interfaces, such as an NIC (Network Interface Card), a MODEM (Modulator-DEModulator) and a USB (Universal Serial Bus), and connects the image forming apparatus 100A to external apparatuses.

The operation unit 14 outputs various types of information set by a user to the controller 11. As the operation unit 14, for example, a touchscreen through which input operations can be made in accordance with information displayed on its display can be used. Through this operation unit 14, a user can set a printing condition(s), such as a paper type (e.g. basis weight, size, paper quality, etc.) of the paper P, a paper feeding tray to be used, an image density, a magnification ratio, and double-sided printing or not (i.e. single-sided printing). Further, through the operation unit 14, a user can input a job execution instruction(s) and an instruction(s) for operation in an adjustment mode. The controller 11 controls the operation unit 14, so that various massages can be displayed for a user through the operation unit 14.

The environment sensor SE2 includes, for example, a temperature sensor and a humidity sensor, and detects temperature and humidity in the casing of the image forming apparatus 100A and outputs the detection result to the controller 11.

### [Operation of Image Forming Apparatus 100A]

Next, operation of the image forming apparatus 100A according to the first embodiment is described.

FIG. 5 is a flowchart showing the sway control process A to control sway of the registration roller pair 27. The process shown in this flowchart is performed by the controller 11 in cooperation with the program stored in the storage 12 in response to a job execution instruction from a user.

When a job is started and the registration sensor SE1 detects arrival of the top of (a sheet of) the paper P (Step S1), the controller 11 causes the drive mechanism 34 to sway the registration roller pair 27 at a rotation start timing of the registration roller pair 27 (Step S2). That is, the controller 11 determines the sway amount and the sway direction of the registration roller pair 27 on the basis of the first sway control table 121 and the correction value table 123, and causes the drive mechanism 34 to sway the registration roller pair 27 by the determined sway amount in the determined sway direction at the sway speed identified in the first sway control table 121 and the correction value table 123 for the paper conveyance condition, such as the paper type of the paper P, and then stop the registration roller pair 27.

Next, the controller 11 determines whether or not the paper P has entered the secondary transfer roller pair 9 (Step S3). That is, the controller 11 determines whether or not the paper P has arrived at the transfer nip part of the intermediate transfer belt 6. In this embodiment, for example, when a predetermined time t1 has elapsed since detection of the top of the paper P by the registration sensor SE1, the controller 11 determines that the paper P has entered the secondary transfer roller pair 9. Alternatively, it is possible that a sensor is arranged near the secondary transfer roller pair 9 in advance, and when this sensor detects the paper P, the controller 11 determines that the paper P has entered the secondary transfer roller pair 9. Still alternatively, the controller 11 may make the determination according to change in pressure of the secondary transfer roller pair 9.

When determining that the paper P has not entered the secondary transfer roller pair 9 yet (Step S3; NO), the controller 11 repeats Step S3.

On the other hand, when determining that the paper P has entered the secondary transfer roller pair 9 (Step S3; YES), the controller 11 waits for a sway timing to come (Step S4). The sway timing is set at intervals of a predetermined time t2 after the predetermined time t1 has elapsed since detection of the top of the paper P by the registration sensor SE1, namely, after the paper P has entered the secondary transfer roller pair 9.

When the sway timing comes (Step S4; YES), the controller 11 causes the drive mechanism 34 to sway the registration roller pair 27 in the sway direction at the sway speed identified in the second sway control table 122 and the correction value table 123 for the paper conveyance condition, such as the paper type of the paper P (Step S5). That is, the controller 11 determines the sway amount and the sway direction of the registration roller pair 27 on the basis of the second sway control table 122 and the correction value table 123, and causes the drive mechanism 34 to sway the registration roller pair 27 by the determined sway amount in the determined sway direction at the sway speed identified in the second sway control table 122 and the correction value table 123 for the paper conveyance condition, such as the paper type of the paper P, and then stop the registration roller pair 27.

In Step S6, the controller 11 determines whether or not the sway at the final sway timing has finished (Step S6). For example, the controller 11 determines whether or not the sway at the final sway timing has finished on the basis of the size of the paper P, the elapsed time since detection of the top of the paper P by the registration sensor SE1 and a conveyance speed of the paper P.

When determining that the sway at the final sway timing has not finished yet (Step S6; NO), the controller 11 returns to Step S4 and waits for the next sway timing, and when the next sway timing comes, causes the drive mechanism 34 to sway the registration roller pair 27, namely, repeats Steps S4 to S6.

As described above, in this embodiment, the position of the side edge of the paper P is corrected not only before the top of the paper P enters the secondary transfer roller pair 9 but also after the top of the paper P enters the secondary transfer roller pair 9 at multiple points in the sub-scanning direction. Accordingly, the position of the side edge of the paper P is corrected not only at the top of the paper P but also at the bottom of the paper P. Hence, for example, sub-scanning curving significant in paper that is long in the paper conveying direction, such as long paper, can be corrected.

On the other hand, when determining that the sway at the final sway timing has finished (Step S6; YES), the controller 11 causes the image reader 60 to read the paper P having a toner image formed by the paper P having passed through the secondary transfer roller pair 9 (Step S7), and calculates the correction values for the sway control information on the basis of the read image obtained by the image reader 60 (Step S8).

In Step S8, for example, the controller 11 identifies the region of the paper P and the region of the toner image from the read image, and obtains the distance between the side edge of the paper P and the toner image at each predetermined point in the sub-scanning direction of the paper P (multiple points including at least: a predetermined point (e.g. the top of the paper P) at which the position of the side edge has been corrected before the paper P has entered the secondary transfer roller pair 9; and multiple points at which the position of the side edge of the paper P has been corrected at the sway timings after the paper P has entered the secondary transfer roller pair 9). Then, for example, the controller 11 calculates, as the deviation amount, a difference between (i) each obtained distance and (ii) its ideal distance, namely, distance between the side edge of the paper P and the toner image when the toner image is written at the image's optimum position, and calculates the correction value for the target position Tp at each point (and the correction value for the sway direction if the point corresponds to a sway timing) on the basis of the calculated deviation amount.

Further, the controller 11 detects noise in the region of the toner image on the basis of the read image obtained by the image reader 60. For example, the controller 11 compares a value(s) of the region of the toner image in the read image with a value(s) of its document image so as to detect noise (image defect). After the paper P enters the secondary transfer roller pair 9, the paper P is swayed by the registration roller pair 27 in a state in which the paper P is sandwiched between and held by the rollers of the secondary transfer roller pair 9. Hence, if the sway speed is too fast, noise due to deviation in transferring or the like is generated. Hence, the controller 11 detects noise in the region of the toner image and calculates the correction value to reduce the sway speed at a point(s) in the sub-scanning direction, the point(s) where noise is generated.

Then, the controller 11 updates the correction value table 123 with the correction value calculated for each point in the sub-scanning direction (Step S9). That is, the controller 11 overwrites the correction values for the paper type (paper conveyance condition) of the paper P in the correction value table 123 with the calculated correction values, and causes the storage 12 to store the overwritten correction value table 123.

Even if the side edge of the paper P is adjusted to be on the target position Tp, sub-scanning curving may occur as described above, and deviation of the image position on the paper P tends to be larger on the bottom side of the paper P. In particular, in the paper that is long in the paper conveying direction, such as long paper, the deviation is significant. In this embodiment, the controller 11 calculates the correction values for the sway control information at least at the predetermined point at which the position of the side edge has been corrected before the paper P has entered the secondary transfer roller pair 9 and the multiple points at which the position of the side edge of the paper P has been corrected at the sway timings after the paper P has entered the secondary transfer roller pair 9, and the calculated correction values are stored in the correction value table 123. This makes it possible to correct each sway control information on the basis of deviation of the image position and/or noise at each point in the sub-scanning direction, and accordingly can suppress, with high accuracy, deviation of the image position on the paper P caused by sub-scanning curving. Further, because the same side edge of the paper P is adjusted always, influence of variation in the external shape of the paper P can be suppressed.

Next, the controller 11 determines whether or not the image transfer for the last page has finished (Step S10).

When determining that the image transfer for the last page has not finished yet (Step S10; NO), the controller 11 returns to Step S1.

On the other hand, when determining that the image transfer for the last page has finished (Step S10; YES), the controller 11 ends the sway control process A.

The above sway control process A is a process of correcting, on the basis of the sway of the registration roller pair 27, the sway control information to be used for the subsequent sway control(s), the sway control process A being performed during execution of a job. The image forming apparatus 100A, however, has the adjustment mode, and in the adjustment mode, can set the correction values to the correction value table 123 or correct the correction values in the correction value table 123 in advance, namely, before execution of a job. For example, when an instruction for operation in the adjustment mode is input through the operation unit 14, the controller 11 lets a predetermined number of sheets of the paper P be fed from the paper feeding tray 21 or the paper feeding tray of the paper feeding apparatus, causes the image forming units 10Y, 10M, 10C, 10K to form toner images on the basis of image data stored in advance in the storage 12, and causes the secondary transfer roller pair 9 to transfer the toner images onto the sheets of the paper P. The controller 11 also performs the same control as the above sway control process A, and thereby causes the drive mechanism 34 to sway the registration roller pair 27, causes the image reader 60 to read the sheets of the paper P onto which the toner images have been transferred, calculates the correction values for the sway control information on the basis of the reading results by the image reader 60, and sets the calculated correction values to the correction value table 123 or corrects the correction values in the correction value table 123 with the calculated correction values. Thus, the image forming apparatus 100A has the adjustment mode, and accordingly can set the correction values to the correction value table 123 or correct the correction values in the correction value table 123 in advance, namely, before execution of a job, and hence can suppress deviation of the image position on the paper P starting from the first sheet of the paper P in a job and produce well-finished prints.

### Second Embodiment

Next, a second embodiment is described.

In the first embodiment, the calculated correction values for the sway control information are stored in the correction value table 123, whereas in the second embodiment, on the basis of the calculated correction values, the sway control information in the first sway control table 121 and the second sway control table 122 are rewritten.

The storage 12 in the second embodiment stores a program to perform a sway control process B described below. The storage 12 in the second embodiment also stores the first sway control table 121 and the second sway control table 122 described in the first embodiment.

Except the above, the configuration in the second embodiment is the same as that described in the first embodiment, and hence the description is not repeated here. Hereinafter, operation in the second embodiment is described.

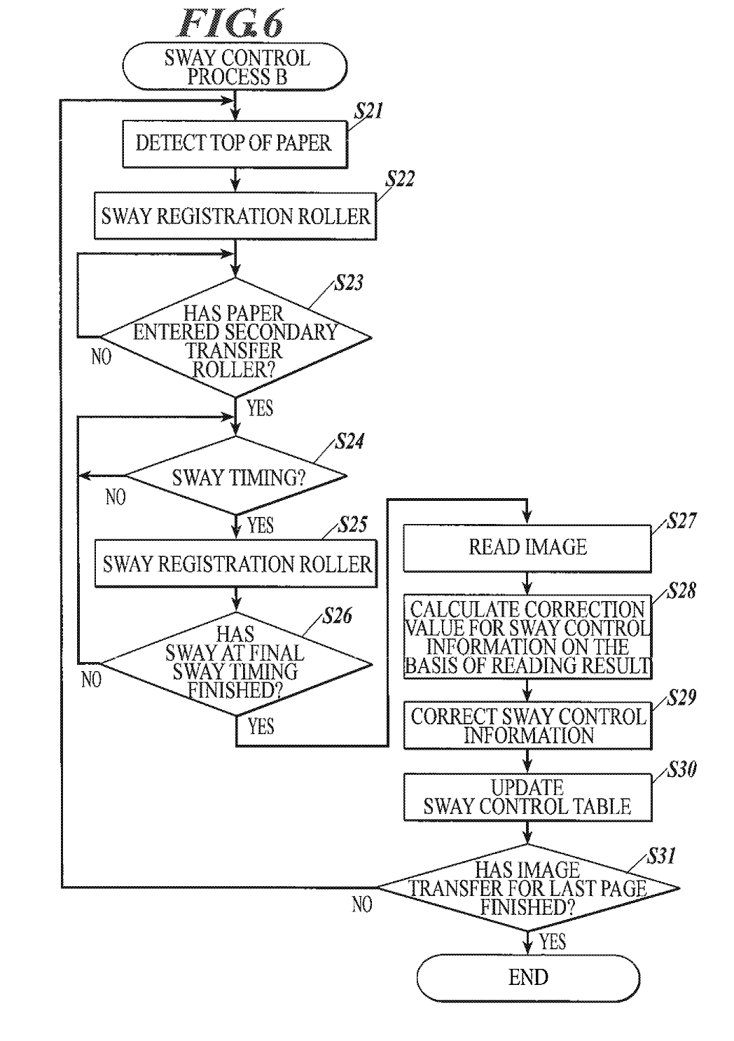

FIG. 6 is a flowchart showing the sway control process B of the registration roller pair 27 that is performed in the second embodiment by the controller 11. The process shown in this flowchart is performed by the controller 11 in cooperation with the program stored in the storage 12 in response to a job execution instruction from a user.

When a job is started, and the registration sensor SE1 detects arrival of the top of (a sheet of) the paper P (Step S21), the controller 11 causes the drive mechanism 34 to sway the registration roller pair 27 at a rotation start timing of the registration roller pair 27 (Step S22). That is, the controller 11 determines the sway amount and the sway direction of the registration roller pair 27 on the basis of the first sway control table 121, and causes the drive mechanism 34 to sway the registration roller pair 27 by the determined sway amount in the determined sway direction at the sway speed identified in the first sway control table 121 for the paper conveyance condition, such as the paper type of the paper P, and then stop the registration roller pair 27.

Next, the controller 11 determines whether or not the paper P has entered the secondary transfer roller pair 9 (Step S23). The determination method in Step S23 is the same as that in Step S3 in FIG. 5, and hence the description is not repeated here.

When determining that the paper P has not entered the secondary transfer roller pair 9 yet (Step S23; NO), the controller 11 repeats Step S23.

On the other hand, when determining that the paper P has entered the secondary transfer roller pair 9 (Step S23; YES), the controller 11 waits for a sway timing to come (Step S24).

When the sway timing comes (Step S24; YES), the controller 11 causes the drive mechanism 34 to sway the registration roller pair 27 in the sway direction at the sway speed identified in the second sway control table 122 for the paper conveyance condition, such as the paper type of the paper P (Step S25). That is, the controller 11 determines the sway amount and the sway direction of the registration roller pair 27 on the basis of the second sway control table 122, and causes the drive mechanism 34 to sway the registration roller pair 27 by the determined sway amount in the determined sway direction at the sway speed identified in the second sway control table 122 for the paper conveyance condition, such as the paper type of the paper P, and then stop the registration roller pair 27.

In Step S26, the controller 11 determines whether or not the sway at the final sway timing has finished (Step S26).

When determining that the sway at the final sway timing has not finished yet (Step S26; NO), the controller 11 returns to Step S24 and waits for the next sway timing, and when the next sway timing comes, causes the drive mechanism 34 to sway the registration roller pair 27, namely, repeats Steps S24 to S26.

On the other hand, when determining that the sway at the final sway timing has finished (Step S26; YES), the controller 11 causes the image reader 60 to read the paper P having a toner image formed by the paper P having passed through the secondary transfer roller pair 9 (Step S27), and calculates the correction values for the sway control information on the basis of the read image obtained by the image reader 60 (Step S28).

In Step S28, for example, the controller 11 identifies the region of the paper P and the region of the toner image from the read image, and calculates the correction value for the sway control information (the target position Tp, the sway direction and the sway speed) at each predetermined point in the sub-scanning direction of the paper P (multiple points including at least: a predetermined point (e.g. the top of the paper P) at which the position of the side edge has been corrected before the paper P has entered the secondary transfer roller pair 9; and multiple points at which the position of the side edge of the paper P has been corrected at the sway timings after the paper P has entered the secondary transfer roller pair 9). The correction value calculation method in Step S28 is the same as that in Step S8 in FIG. 5, and hence the description is not repeated here.

Then, the controller 11 corrects the sway control information in the first sway control table 121 and the second sway control table 122 on the basis of the correction value calculated for each point in the sub-scanning direction (Step S29), and updates the first sway control table 121 and the second sway control table 122 with the corrected sway control information (Step S30). That is, the controller 11 corrects the sway control information for the respective sway timings for the paper conveyance condition, such as the paper type of the paper P, in the first sway control table 121 and the second sway control table 122 with the calculated correction values, and causes the storage 12 to store the corrected first sway control table 121 and second sway control table 122.

Even if the side edge of the paper P is adjusted to be on the target position Tp, sub-scanning curving may occur as described above, and deviation of the image position on the paper P tends to be larger one the bottom side of the paper P. In this embodiment, the controller 11 corrects the (pieces of) sway control information at least at the predetermined point at which the position of the side edge has been corrected before the paper P has entered the secondary transfer roller pair 9 and the multiple points at which the position of the side edge of the paper P has been corrected at the sway timings after the paper P has entered the secondary transfer roller pair 9, and the corrected sway control information is stored in the first sway control table 121 and the second sway control table 122. This makes it possible to correct each sway control information on the basis of deviation of the image position and/or noise at each point in the sub-scanning direction, and accordingly can suppress, with high accuracy, deviation of the image position on the paper P caused by sub-scanning curving. Further, because the same side edge of the paper P is adjusted always, influence of variation in the external shape of the paper P can be suppressed.

Next, the controller 11 determines whether or not the image transfer for the last page has finished (Step S31).

When determining that the image transfer for the last page has not finished yet (Step S31; NO), the controller 11 returns to Step S21.

On the other hand, when determining that the image transfer for the last page has finished (Step S31; YES), the controller 11 ends the sway control process B.

The above sway control process B is a process of correcting, on the basis of the sway of the registration roller pair 27, the sway control information to be used for the subsequent sway control(s), the sway control process B being performed during execution of a job. The image forming apparatus 100A, however, has the adjustment mode, and in the adjustment mode, can set the sway control information to the first sway control table 121 and the second sway control table 122 or correct the sway control information in the first sway control table 121 and the second sway control table 122 in advance, namely, before execution of a job. For example, when an instruction for operation in the adjustment mode is input through the operation unit 14, the controller 11 lets a predetermined number of sheets of the paper P be fed from the paper feeding tray 21 or the paper feeding tray of the paper feeding apparatus, causes the image forming units 10Y, 10M, 10C, 10K to form toner images on the basis of image data stored in advance in the storage 12, and causes the secondary transfer roller pair 9 to transfer the toner images onto the sheets of the paper P. The controller 11 also performs the same control as the above sway control process B, and thereby causes the drive mechanism 34 to sway the registration roller pair 27, causes the image reader 60 to read the sheets of the paper P onto which the toner images have been transferred, and sets the sway control information to the first sway control table 121 and the second sway control table 122 or corrects the sway control information in the first sway control table 121 and the second sway control table 122 on the basis of the reading results by the image reader 60. Thus, the image forming apparatus 100A has the adjustment mode, and accordingly can set the sway control information to the first sway control table 121 and the second sway control table 122 or correct the sway control information in the first sway control table 121 and the second sway control table 122 in advance, namely, before execution of a job, and hence can suppress deviation of the image position on the paper P starting from the first sheet of the paper P in a job and produce well-finished prints.

As described above, the image forming apparatus 100A includes the registration roller pair 27 constituted of a pair of rollers which conveys the paper P to the secondary transfer roller pair 9 constituted of a pair of rollers, the paper P being conveyed to the registration roller pair 27, and the controller 11 makes the registration roller pair 27 sway on the basis of predetermined sway control information. The controller 11 then causes the image reader 60 to read the paper P onto which an image has been transferred by the paper P having passed through the secondary transfer roller pair 9, and corrects the sway control information on the basis of the reading result.

Thus, the image forming apparatus 100A corrects the sway control information on the basis of deviation of the toner image position on the paper P after the image transfer, and accordingly can suppress, with high accuracy, deviation of the image position on the paper P caused by sub-scanning curving.

More specifically, the controller 11 makes the registration roller pair 27 sway on the basis of the corrected sway control information, thereby controlling the position of the side edge of the paper P. This can suppress, with high accuracy, deviation of the image position on the paper P caused by sub-scanning curving.

Further, for example, the controller 11 corrects, on the basis of the reading result by the image reader 60, the sway control information that is used for the sway control of the registration roller pair 27 before the paper P enters the secondary transfer roller pair 9 and after the paper P enters the secondary transfer roller pair 9. Thus, the image forming apparatus 100A adjusts the position of the side edge of the paper P even after the paper P enters the secondary transfer roller pair 9. This can suppress, with high accuracy, deviation of the image position on the paper P caused by sub-scanning curving.

Further, for example, the controller 11 determines the correction value for the sway control information on the basis of the reading result by the image reader 60, and causes the storage 12 to store the determined correction value. This allows the correction value to be used for the next job(s) and even after power of the image forming apparatus 100A is turned off. Further, for example, the controller 11 causes the storage 12 to store the table for the paper conveyance condition, the table where the correction value for the sway control information is stored. This enables the optimum sway control for the condition in image forming (i.e. the paper conveyance condition).

Further, for example, the controller 11 causes the storage 12 to store the table for the paper conveyance condition, the table where the sway control information is stored, and corrects the sway control information stored in the table with the correction value determined on the basis of the reading result by the image reader 60. This makes it possible to correct and then store the sway control information for the paper conveyance condition.

Further, the image forming apparatus 100A has the adjustment mode, and in response to an instruction for operation in the adjustment mode, operates in the adjustment mode of automatically feeding the paper P, transferring an image onto the paper P, reading the paper P with the image reader 60, and correcting the first sway control table 121, the second sway control table 122 and/or the correction value table 123 on the basis of the reading result. This makes it possible to set the optimum sway control information and/or correction value in advance, namely, before execution of a job.

Further, the controller 11 makes the registration roller pair 27 sway at each of predetermined multiple timings on the basis of the sway control information, and corrects the sway control information at each of the multiple timings on the basis of the reading result by the image reader 60. This can suppress, with higher accuracy, deviation of the image position on the paper P caused by sub-scanning curving.

### Third Embodiment

Next, a third embodiment is described.

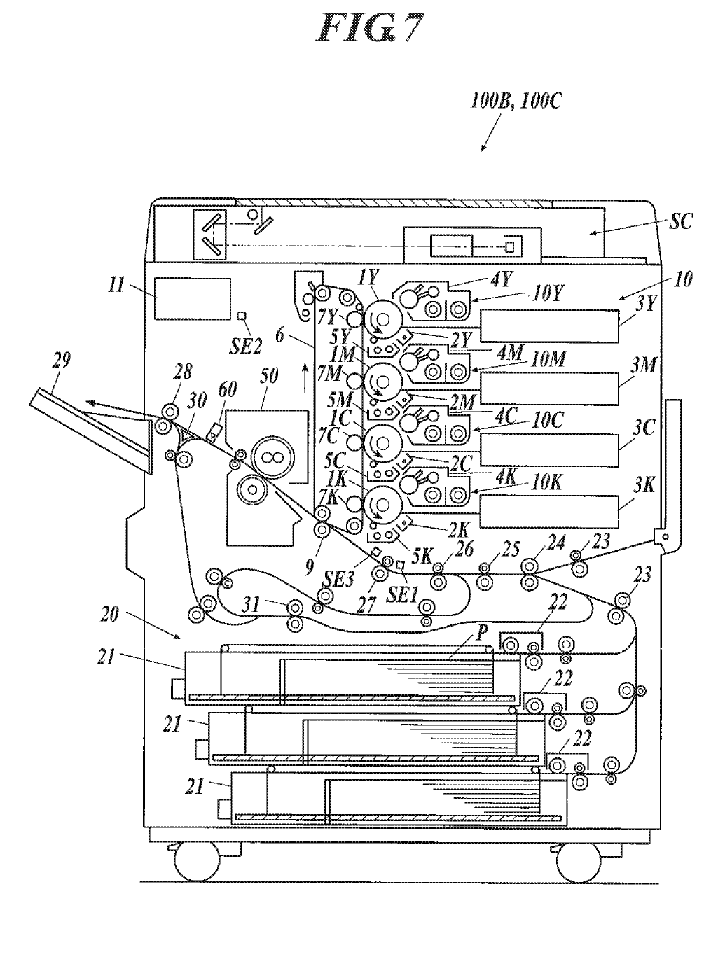

FIG. 7 schematically shows an image forming apparatus 100B according to the third embodiment.

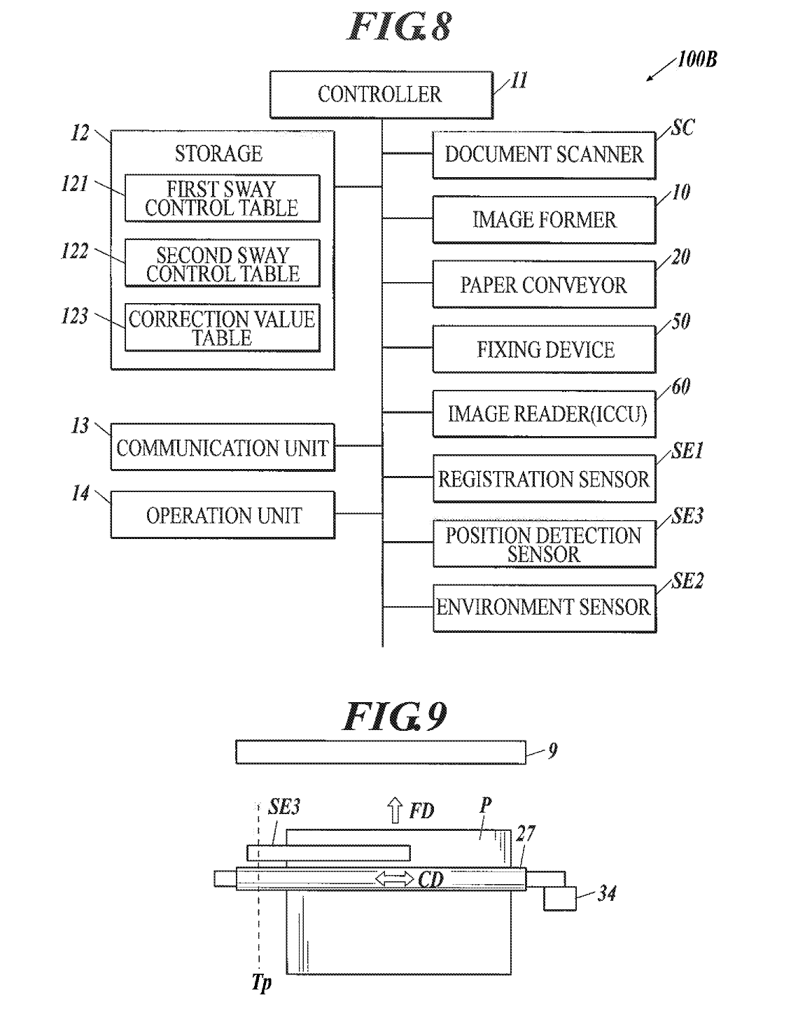

FIG. 8 is a block diagram schematically showing configuration of a control system of the image forming apparatus 100B according to the third embodiment.

As shown in FIG. 7, a position detection sensor SE3 is provided over the conveyance path of the image forming apparatus 100B between the registration roller pair 27 and the secondary transfer roller pair 9.

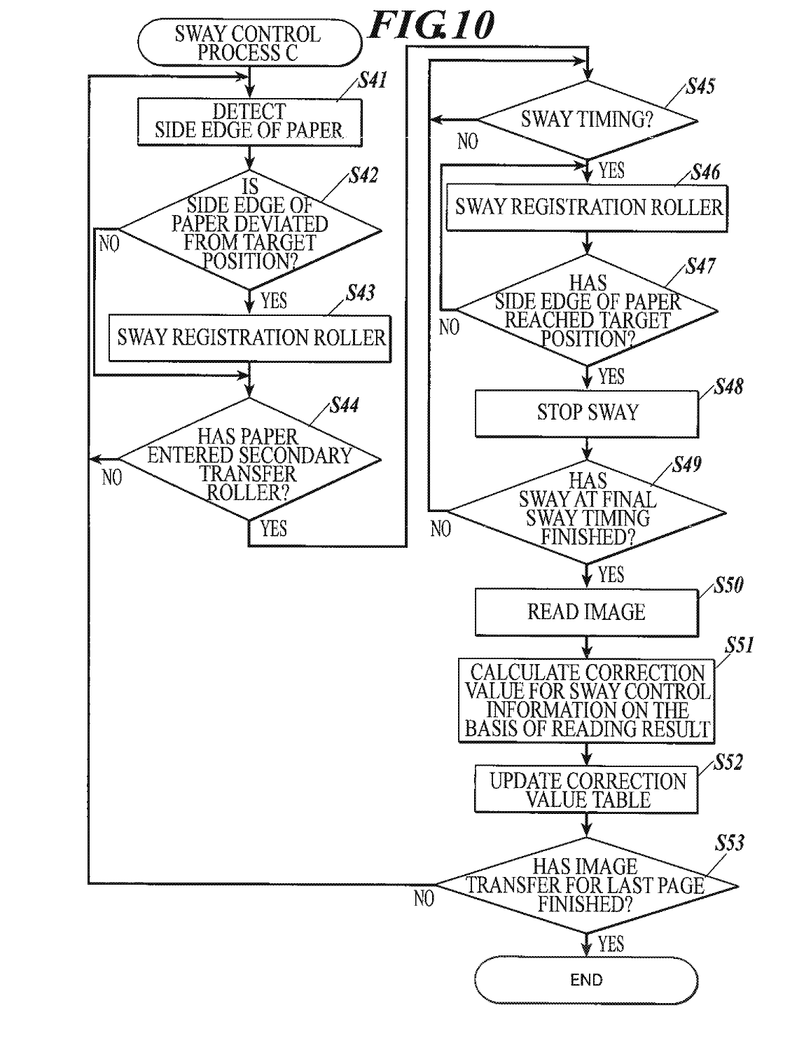

As shown in FIG. 9, the position detection sensor SE3 detects the position in the paper width direction CD of the side edge of the paper P. Examples of the position detection sensor SE3 to be used include a linear image sensor (e.g. a CCD line sensor) in which light receiving elements are arranged linearly along the paper width direction CD. The detection result(s) by the position detection sensor SE3 is output to the controller 11, and used to determine the movement amount (i.e. the sway amount) of the registration roller pair 27 in the sway process and to recognize the timing at which the top of the paper P enters the secondary transfer roller pair 9.

The storage 12 in the third embodiment stores a program to perform a sway control process C described below. The storage 12 in the third embodiment also stores the first sway control table 121, the second sway control table 122 and the correction value table 123 described in the first embodiment.

Except the above, the configuration of the image forming apparatus 100B in the second embodiment is the same as that of the image forming apparatus 100A described in the first embodiment, and hence the same reference numbers are given to the same components and the description is not repeated here. Hereinafter, operation of the image forming apparatus 100B in the third embodiment is described.

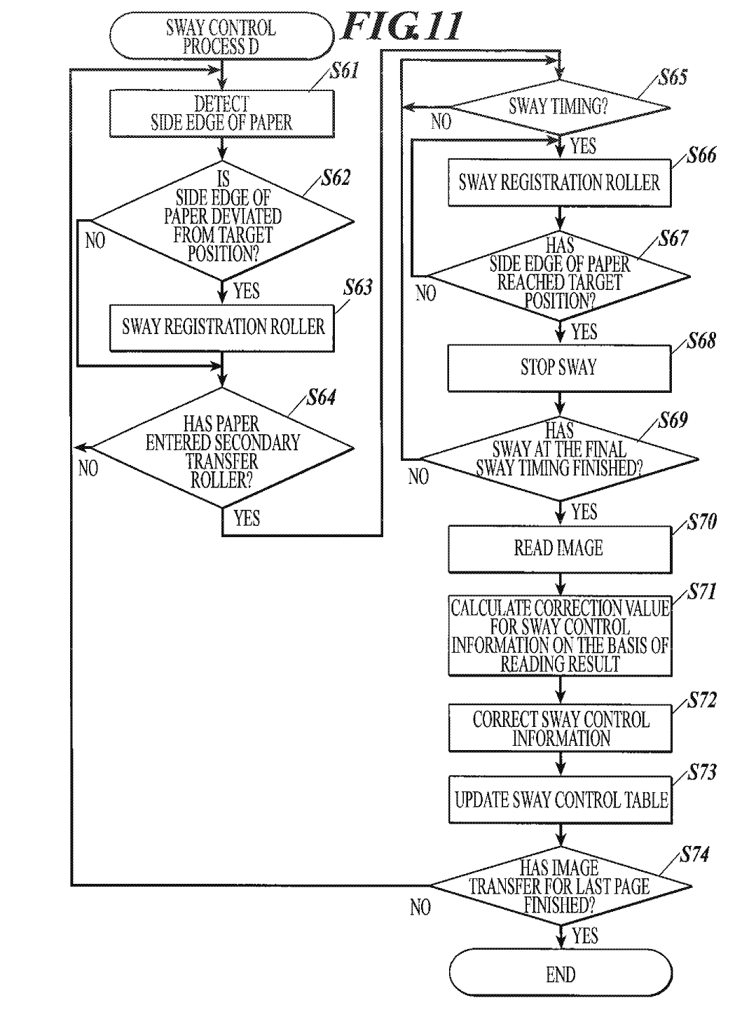

FIG. 10 is a flowchart showing the sway control process C of the registration roller pair 27 that is performed in the third embodiment by the controller 11. The process shown in this flowchart is performed by the controller 11 in cooperation with the program stored in the storage 12 in response to a job execution instruction from a user.

When a job is started and the position detection sensor SE3 detects the position of the side edge of (a sheet of) the paper P (Step S41), the controller 11 determines whether or not the side edge of the paper P is deviated from the target position Tp on the basis of (i) the detection result by the position detection sensor SE3 and (ii) the target position Tp identified in the first sway control table 121 and the correction value table 123 for the paper conveyance condition (Step S42).

When determining that the side edge of the paper P is not deviated from the target position Tp (Step S42; NO), the controller 11 proceeds to Step S44.

On the other hand, when determining that the side edge of the paper P is deviated from the target position Tp (Step S42; YES), the controller 11 causes the drive mechanism 34 to sway the registration roller pair 27 (Step S43) and proceeds to Step S44. That is, the controller 11 determines the sway amount and the sway direction of the registration roller pair 27 on the basis of the deviation amount of the detected position of the side edge of the paper P from the target position Tp, and causes the drive mechanism 34 to sway the registration roller pair 27 by the determined sway amount in the determined sway direction at the sway speed identified in the first sway control table 121 and the correction value table 123 for the paper conveyance condition, and then stop the registration roller pair 27.

In Step S44, the controller 11 determines whether or not the paper P has entered the secondary transfer roller pair 9 (Step S44). In this embodiment, for example, when a predetermined time t1 has elapsed since detection of the top of the paper P by the position detection sensor SE3, the controller 11 determines that the paper P has entered the secondary transfer roller pair 9. Alternatively, it is possible that a sensor is arranged near the secondary transfer roller pair 9 in advance, and when this sensor detects the paper P, the controller 11 determines that the paper P has entered the secondary transfer roller pair 9. Still alternatively, the controller 11 may make the determination according to change in pressure of the secondary transfer roller pair 9.

When determining that the paper P has not entered the secondary transfer roller pair 9 yet (Step S44; NO), the controller 11 returns to Step S41 and repeats Steps S41 to S44.

On the other hand, when determining that the paper P has entered the secondary transfer roller pair 9 (Step S44; YES), the controller 11 waits for a sway timing to come (Step S45). The sway timing is set at intervals of a predetermined time t2 after the predetermined time t1 has elapsed since detection of the top of the paper P by the position detection sensor SE3, namely, after the paper P has entered the secondary transfer roller pair 9.

When the sway timing comes (Step S45; YES), the controller 11 causes the drive mechanism 34 to sway the registration roller pair 27 in the sway direction at the sway speed identified in the second sway control table 122 and the correction value table 123 for the sway timing and the paper conveyance condition (Step S46), and determines on the basis of the detection result by the position detection sensor SE3 whether or not the side edge of the paper P has reached the target position Tp identified in the second sway control table 122 and the correction value table 123 for the sway timing and the paper conveyance condition (Step S47).

When determining that the side edge of the paper P has not reached the target position Tp yet (Step S47; NO), the controller 11 returns to Step S46 so that the registration roller pair 27 keep swaying.

On the other hand, when determining that the side edge of the paper P has reached the target position Tp (Step S47; YES), the controller 11 causes the drive mechanism 34 to stop the sway of the registration roller pair 27 (Step S48) and proceeds to Step S49.

Note that the controller 11 determines on the basis of the position of the side edge of the paper P detected by the position detection sensor SE3 whether or not the sway direction is a direction to be away from the target position Tp, and when determining that the sway direction is the direction to be away from the target position Tp, the controller 11 immediately proceeds to Step S48 so that the registration roller pair 27 stops swaying.

In Step S9, the controller 11 determines whether or not the sway at the final sway timing has finished (Step S49). For example, the controller 11 determines whether or not the sway at the final sway timing has finished on the basis of the size of the paper P, the elapsed time since detection of the top of the paper P by the position detection sensor SE3 and the conveyance speed.

When determining that the sway at the final sway timing has not finished yet (Step S49; NO), the controller 11 returns to Step S45 and waits for the next sway timing, and when the next sway timing comes, causes the drive mechanism 34 to sway the registration roller pair 27, and when the side edge of the paper P has reached the target position Tp, stop the sway of the registration roller pair 27, namely, repeats Steps S45 to S49.

As described above, in this embodiment, the position of the side edge of the paper P is corrected not only before the top of the paper P enters the secondary transfer roller pair 9 but also after the paper P enters the secondary transfer roller pair 9 at multiple points in the sub-scanning direction. Accordingly, the position of the side edge of the paper P is corrected not only at the top of the paper P but also at the bottom of the paper P. Hence, for example, sub-scanning curving significant in the paper that is long in the paper conveying direction, such as long paper, can be corrected.

On the other hand, when determining that the sway at the final sway timing has finished (Step S49; YES), the controller 11 causes the image reader 60 to read the paper P having a toner image formed by the paper P having passed through the secondary transfer roller pair 9 (Step S50), and calculates the correction values for the sway control information on the basis of the read image obtained by the image reader 60 (Step S51).

In Step S51, for example, the controller 11 identifies the region of the paper P and the region of the toner image from the read image, and obtains the distance between the side edge of the paper P and the toner image at each predetermined point in the sub-scanning direction of the paper P (multiple points including at least: a predetermined point (e.g. the top of the paper P) at which the position of the side edge has been corrected before the paper P has entered the secondary transfer roller pair 9; and multiple points at which the position of the side edge of the paper P has been corrected at the sway timings after the paper P has entered the secondary transfer roller pair 9). Then, for example, the controller 11 calculates, as the deviation amount, a difference between (i) each obtained distance and (ii) its ideal distance, namely, distance between the side edge of the paper P and the toner image when the toner image is written at the image's optimum position, and calculates the correction value for the target position Tp at each point (and the correction value for the sway direction if the point corresponds to a sway timing) on the basis of the calculated deviation amount.

Further, the controller 11 detects noise in the region of the toner image on the basis of the read image obtained by the image reader 60. For example, the controller 11 compares a value(s) of the region of the toner image in the read image with a value(s) of its document image so as to detect noise (image defect). After the paper P enters the secondary transfer roller pair 9, the paper P is swayed by the registration roller pair 27 in the state in which the paper P is sandwiched between and held by the rollers of the secondary transfer roller pair 9. Hence, if the sway speed is too fast, noise due to deviation in transferring or the like is generated. Hence, the controller 11 detects noise in the region of the toner image and calculates the correction value to reduce the sway speed at a point(s) in the sub-scanning direction, the point(s) where noise is generated.

Then, the controller 11 updates the correction value table 123 with the correction value calculated for each point in the sub-scanning direction (Step S52). That is, the controller 11 overwrites the correction values for the respective points in the sub-scanning direction for the paper conveyance condition in the correction value table 123 with the calculated correction values, and causes the storage 12 to store the overwritten correction value table 123.

Even if the side edge of the paper P is adjusted to be on the target position Tp at the position of the position detection sensor SE3, sub-scanning curving may occur as described above, and deviation of the image position on the paper P tends to be larger on the bottom side of the paper P. In particular, in the paper that is long in the paper conveying direction, such as long paper, the deviation is significant. In this embodiment, the controller 11 calculates the correction values for the sway control information at least at the predetermined point at which the position of the side edge has been corrected before the paper P has entered the secondary transfer roller pair 9 and the multiple points at which the position of the side edge of the paper P has been corrected at the sway timings after the paper P has entered the secondary transfer roller pair 9, and the calculated correction values are stored in the correction value table 123. This makes it possible to correct each sway control information on the basis of deviation of the image position and/or noise at each point in the sub-scanning direction, and accordingly can suppress, with high accuracy, deviation of the image position on the paper P caused by sub-scanning curving. Further, because the same side edge of the paper P is adjusted always, influence of variation in the external shape of the paper P can be suppressed.

Next, the controller 11 determines whether or not the image transfer for the last page has finished (Step S53).

When determining that the image transfer for the last page has not finished yet (Step S53; NO), the controller 11 returns to Step S41.

On the other hand, when determining that the image transfer for the last page has finished (Step S53; YES), the controller 11 ends the sway control process C.

The above sway control process C is a process of correcting, on the basis of the sway of the registration roller pair 27, the sway control information to be used for the subsequent sway control(s), the sway control process C being performed during execution of a job. The image forming apparatus 100B, however, has the adjustment mode, and in the adjustment mode, can set the correction values to the correction value table 123 or correct the correction values in the correction value table 123 in advance, namely, before execution of a job. For example, when an instruction for operation in the adjustment mode is input through the operation unit 14, the controller 11 lets a predetermined number of sheets of the paper P be fed from the paper feeding tray 21 or the paper feeding tray of the paper feeding apparatus, causes the image forming units 10Y, 10M, 10C, 10K to form toner images on the basis of image data stored in advance in the storage 12, and causes the secondary transfer roller pair 9 to transfer the toner images onto the sheets of the paper P. The controller 11 also performs the same control as the above sway control process C, and thereby causes the drive mechanism 34 to sway the registration roller pair 27, causes the image reader 60 to read the sheets of the paper P onto which the toner images have been transferred, calculates the correction values for the sway control information on the basis of the reading results by the image reader 60, and sets the calculated correction values to the correction value table 123 or corrects the correction values in the correction value table 123 with the calculated correction values. Thus, the image forming apparatus 100B has the adjustment mode, and accordingly can set the correction values to the correction value table 123 or correct the correction values in the correction value table 123 in advance, namely, before execution of a job, and hence can suppress deviation of the image position on the paper P starting from the first sheet of the paper P in a job and produce well-finished prints.

### Fourth Embodiment

Next, a fourth embodiment is described.

In the third embodiment, the calculated correction values for the sway control information are stored in the correction value table 123, whereas in the fourth embodiment, the sway control information corrected with the calculated correction values is stored in the first sway control table 121 and the second sway control table 122.

The storage 12 in the fourth embodiment stores a program to perform a sway control process D described below. The storage 12 in the fourth embodiment also stores the first sway control table 121 and the second sway control table 122 described in the first embodiment.

Except the above, the configuration in the fourth embodiment is the same as that described in the third embodiment, and hence the description is not repeated here. Hereinafter, operation in the fourth embodiment is described.

FIG. 11 is a flowchart showing the sway control process D of the registration roller pair 27 that is performed in the fourth embodiment by the controller 11. The process shown in this flowchart is performed by the controller 11 in cooperation with the program stored in the storage 12 in response to a job execution instruction from a user.

When a job is started and the position detection sensor SE3 detects the position of the side edge of (a sheet of) the paper P (Step S61), the controller 11 determines whether or not the side edge of the paper P is deviated from the target position Tp on the basis of (i) the detection result by the position detection sensor SE3 and (ii) the target position Tp identified in the first sway control table 121 for the paper conveyance condition (Step S62).

When determining that the side edge of the paper P is not deviated from the target position Tp (Step S62; NO), the controller 11 proceeds to Step S64.

On the other hand, when determining that the side edge of the paper P is deviated from the target position Tp (Step S62; YES), the controller 11 determines the sway amount and the sway direction of the registration roller pair 27 on the basis of the deviation amount of the detected position of the side edge of the paper P from the target position Tp, and causes the drive mechanism 34 to sway the registration roller pair 27 by the determined sway amount in the determined sway direction at the sway speed identified in the first sway control table 121 for the paper conveyance condition (Step S63) and proceeds to Step S64.

In Step S64, the controller 11 determines whether or not the paper P has entered the secondary transfer roller pair 9 (Step S64). The determination method in Step S64 is the same as that in Step S44 in FIG. 10, and hence the description is not repeated here.

When determining that the paper P has not entered the secondary transfer roller pair 9 yet (Step S64; NO), the controller 11 returns to Step S61 and repeats Steps S61 to S64.

On the other hand, when determining that the paper P has entered the secondary transfer roller pair 9 (Step S64; YES), the controller 11 waits for a sway timing to come (Step S65). The sway timing is set at intervals of the predetermined time t2 after the predetermined time t1 has elapsed since detection of the top of the paper P by the position detection sensor SE3, namely, after the paper P has entered the secondary transfer roller pair 9.

When the sway timing comes (Step S65; YES), the controller 11 causes the drive mechanism 34 to sway the registration roller pair 27 in the sway direction at the sway speed identified in the second sway control table 122 for the sway timing and the paper conveyance condition (Step S66), and determines on the basis of the detection result by the position detection sensor SE3 whether or not the side edge of the paper P has reached the target position Tp identified in the second sway control table 122 for the sway timing and the paper conveyance condition (Step S67).

When determining that the side edge of the paper P has not reached the target position Tp yet (Step S67; NO), the controller 11 returns to Step S66 so that the registration roller pair 27 keeps swaying.

On the other hand, when determining that the side edge of the paper P has reached the target position Tp (Step S67; YES), the controller 11 causes the drive mechanism 34 to stop sway of the registration roller pair 27 (Step S68) and proceeds to Step S69.

Note that the controller 11 determines on the basis of the position of the side edge of the paper P detected by the position detection sensor SE3 whether or not the sway direction is the direction to be away from the target position Tp, and when determining that the sway direction is the direction to be away from the target position Tp, the controller 11 immediately proceeds to Step S68 so that the registration roller pair 27 stops swaying.

In Step S69, the controller 11 determines whether or not the sway at the final sway timing has finished (Step S69). For example, the controller 11 determines whether or not the sway at the final sway timing has finished on the basis of the size of the paper P, the elapsed time since detection of the top of the paper P by the position detection sensor SE3 and the conveyance speed.

When determining that the sway at the final sway timing has not finished yet (Step S69; NO), the controller 11 returns to Step S65 and waits for the next sway timing, and when the next sway timing comes, causes the drive mechanism 34 to sway the registration roller pair 27, and when the side edge of the paper P has reached the target position Tp, stop the sway of the registration roller pair 27, namely, repeats Steps S65 to S69.

As described above, in this embodiment, the position of the side edge of the paper P is corrected not only before the top of the paper P enters the secondary transfer roller pair 9 but also after the top of the paper P enters the secondary transfer roller pair 9 at multiple points in the sub-scanning direction. Accordingly, the position of the side edge of the paper P is corrected not only at the top of the paper P but also at the bottom of the paper P. Hence, for example, sub-scanning curving significant in the paper that is long in the paper conveying direction, such as long paper, can be corrected.

On the other hand, when determining that the sway at the final sway timing has finished (Step S69; YES), the controller 11 causes the image reader 60 to read the paper P having a toner image formed by the paper P having passed through the secondary transfer roller pair 9 (Step S70), and calculates the correction values for the sway control information on the basis of the read image obtained by the image reader 60 (Step S71).

In Step S71, for example, the controller 11 identifies the region of the paper P and the region of the toner image from the read image, and calculates the correction value for the sway control information (the target position Tp, the sway direction and the sway speed) at each predetermined point in the sub-scanning direction of the paper P (multiple points including at least: a predetermined point (e.g. the top of the paper P) at which the position of the side edge has been corrected before the paper P has entered the secondary transfer roller pair 9; and multiple points at which the position of the side edge of the paper P has been corrected at the sway timings after the paper P has entered the secondary transfer roller pair 9). The correction value calculation method in Step S71 is the same as that in Step S51 in FIG. 10, and hence the description is not repeated here.

Then, the controller 11 corrects the sway control information in the first sway control table 121 and the second sway control table 122 on the basis of the correction value calculated for each point in the sub-scanning direction (Step S72), and updates the first sway control table 121 and the second sway control table 122 with the corrected sway control information (Step S73). That is, the controller 11 corrects the (pieces of) sway control information for the respective sway timings for the paper conveyance condition in the first sway control table 121 and the second sway control table 122 with the calculated correction values, and causes the storage 12 to store the corrected first sway control table 121 and second sway control table 122.

Even if the side edge of the paper P is adjusted to be on the target position Tp at the position of the position detection sensor SE3, sub-scanning curving may occur as described above, and deviation of the image position on the paper P tends to be larger one the bottom side of the paper P. In particular, in the paper that is long in the paper conveying direction, such as long paper, the deviation is significant. In this embodiment, the controller 11 corrects the (pieces of) sway control information at least at the predetermined point at which the position of the side edge has been corrected before the paper P has entered the secondary transfer roller pair 9 and the multiple points at which the position of the side edge of the paper P has been corrected at the sway timings after the paper P has entered the secondary transfer roller pair 9, and the corrected sway control information is stored in the first sway control table 121 and the second sway control table 122. This makes it possible to correct each sway control information on the basis of deviation of the image position and/or noise at each point in the sub-scanning direction, and accordingly can suppress, with high accuracy, deviation of the image position on the paper P caused by sub-scanning curving. Further, because the same side edge of the paper P is adjusted always, influence of variation in the external shape of the paper P can be suppressed.

Next, the controller 11 determines whether or not the image transfer for the last page has finished (Step S74).

When determining that the image transfer for the last page has not finished yet (Step S74; NO), the controller 11 returns to Step S61.

On the other hand, when determining that the image transfer for the last page has finished (Step S74; YES), the controller 11 ends the sway control process D.

The above sway control process D is a process of correcting, on the basis of the sway of the registration roller pair 27, the sway control information to be used for the subsequent sway control(s), the sway control process D being performed during execution of a job. The image forming apparatus 100B, however, has the adjustment mode, and in the adjustment mode, can set the sway control information to the first sway control table 121 and the second sway control table 122 or correct the sway control information in the first sway control table 121 and the second sway control table 122 in advance, namely, before execution of a job. For example, when an instruction for operation in the adjustment mode is input through the operation unit 14, the controller 11 lets a predetermined number of sheets of the paper P be fed from the paper feeding tray 21 or the paper feeding tray of the paper feeding apparatus, causes the image forming units 10Y, 10M, 10C, 10K to form toner images on the basis of image data stored in advance in the storage 12, and causes the secondary transfer roller pair 9 to transfer the toner images onto the sheets of the paper P. The controller 11 also performs the same control as the above sway control process D, and thereby causes the drive mechanism 34 to sway the registration roller pair 27, causes the image reader 60 to read the sheets of the paper P onto which the toner images have been transferred, and sets the sway control information to the first sway control table 121 and the second sway control table 122 or corrects the sway control information in the first sway control table 121 and the second sway control table 122 on the basis of the reading results by the image reader 60. Thus, the image forming apparatus 100B has the adjustment mode, and accordingly can set the sway control information to the first sway control table 121 and the second sway control table 122 or correct the sway control information in the first sway control table 121 and the second sway control table 122 in advance, namely, before execution of a job, and hence can suppress deviation of the image position on the paper P starting from the first sheet of the paper P in a job and produce well-finished prints.

As described above, according to the image forming apparatus 100B of the third and fourth embodiments, before the paper P enters the secondary transfer roller pair 9, the controller 11 makes the registration roller pair 27 sway on the basis of the detection result by the position detection sensor SE3 and predetermined sway control information stored in the first sway control table 121, and after the paper P enters the secondary transfer roller pair 9, the controller 11 makes the registration roller pair 27 sway on the basis of predetermined sway control information stored in the second sway control table 122 and makes the registration roller pair 27 stop swaying on the basis of the detection result by the position detection sensor SE3. The controller 11 then causes the image reader 60 to read the paper P onto which an image has been transferred by the paper P having passed through the secondary transfer roller pair 9, and corrects the sway control information on the basis of the reading result.

Thus, the image forming apparatus 100B adjusts the position of the side edge of the paper P even after the paper P enters the secondary transfer roller pair 9, and corrects the sway control information on the basis of deviation of the toner image position on the paper P after the image transfer, and accordingly can suppress, with high accuracy, deviation of the image position on the paper P caused by sub-scanning curving.

Further, for example, the controller 11 corrects, on the basis of the reading result by the image reader 60, the sway control information that is used for the sway control of the registration roller pair 27 before the paper P enters the secondary transfer roller pair 9. This can suppress, with high accuracy, deviation of the image position on the paper P at the top of the paper P caused by sub-scanning curving.

Further, for example, the controller 11 corrects, on the basis of the reading result by the image reader 60, the sway control information that is used for the sway control of the registration roller pair 27 after the paper P enters the secondary transfer roller pair 9. This can suppress, with high accuracy, deviation of the image position on the paper P at the bottom of the paper P caused by sub-scanning curving.

Further, for example, the controller 11 determines the correction value for the sway control information on the basis of the reading result by the image reader 60, and causes the storage 12 to store the determined correction value. This allows the correction value to be used for the next job(s) and even after power of the image forming apparatus 100B is turned off. Further, for example, the controller 11 causes the storage 12 to store the table for the paper conveyance condition, such as the paper type, the environment, the print side and/or the paper feeding tray, the table where the correction value for the sway control information is stored. This enables the optimum sway control for the paper conveyance condition.

Further, for example, the controller 11 causes the storage 12 to store the table for the paper conveyance condition, such as the paper type, the environment, the print side and/or the paper feeding tray, the table where the sway control information is stored, and corrects the sway control information for the paper conveyance condition stored in the table with the correction value determined on the basis of the reading result by the image reader 60. This enables the optimum sway control for the paper conveyance condition.

Further, the image forming apparatus 100B has the adjustment mode, and in response to an instruction for operation in the adjustment mode, operates in the adjustment mode of automatically feeding the paper P, transferring an image onto the paper P, reading the paper P with the image reader 60, and correcting the first sway control table 121, the second sway control table 122 and/or the correction value table 123 on the basis of the reading result. This makes it possible to set the optimum sway control information and/or correction value in advance, namely, before execution of a job.

Further, the controller 11 makes the registration roller pair 27 sway at each of predetermined multiple timings on the basis of the sway control information, and corrects the sway control information at each of the multiple timings on the basis of the reading result by the image reader 60. This can suppress, with higher accuracy, deviation of the image position on the paper P caused by sub-scanning curving.

### Fifth Embodiment

Next, a fifth embodiment is described.

FIG. 7 schematically shows an image forming apparatus 100C according to the fifth embodiment.

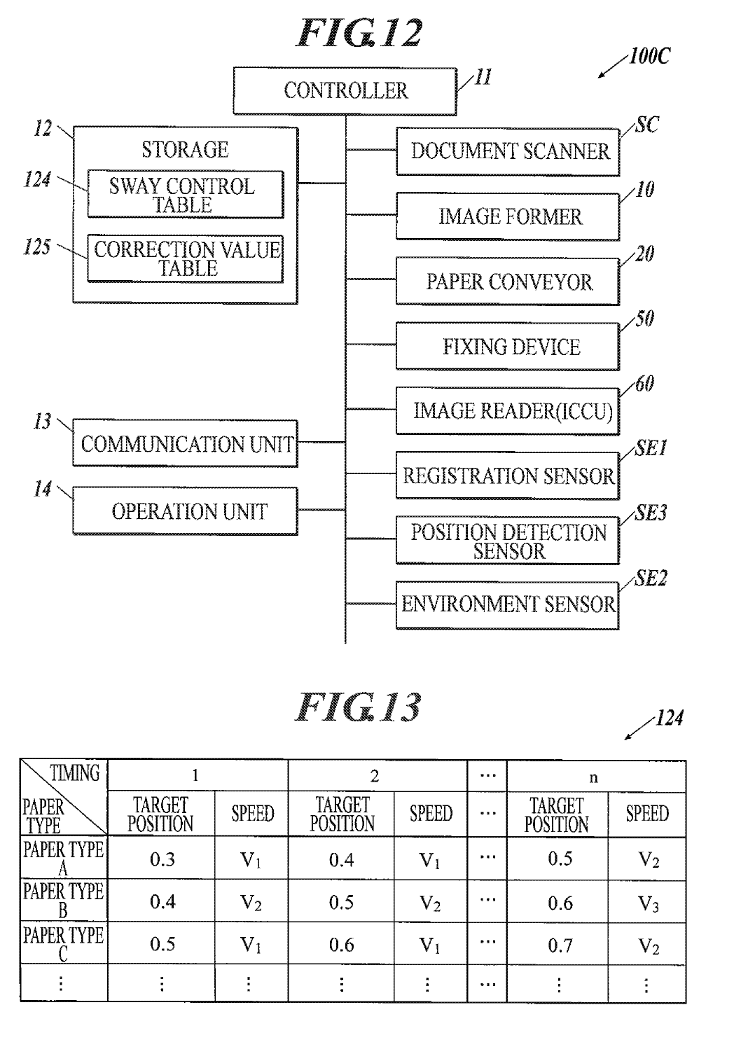

FIG. 12 is a block diagram schematically showing configuration of a control system of the image forming apparatus 100C according to the fifth embodiment.

The storage 12 in the fifth embodiment stores a program to perform a sway control process E described below. The storage 12 in the fifth embodiment also stores a sway control table 124 and a correction value table 125 as shown in FIG. 12.

The sway control table 124 is a table where the (pieces of) sway control information (here, as examples, the target position Tp for the paper P and the sway speed) to control the sway of the registration roller pair 27 is stored. In the sway control table 124, the sway control information for each of the sway timings (timings 1 to n) at which the sway control of the registration roller pair 27 is performed is stored. In this embodiment, the sway control information for each of the timings 1 to n is stored, wherein a timing at which the position detection sensor SE3 detects the top of the paper P is regarded as 0 second(s), a section from 0 second(s) to T1 second(s) is regarded as a timing 1, a section from T1 second(s) to T2 second(s) is regarded as a timing 2, . . . , and a section from Tn-1 second(s) to Tn second(s) (Tn being a timing at which the paper P comes out of (i.e. passes through) the registration roller pair 27, for example) is regarded as a timing n. Alternatively, the sway control information for each detection timing by the position detection sensor SE3, thereby being a larger number of the pieces of sway control information, may be stored. The timings 1 to n include a timing(s) before the paper P enters the secondary transfer roller pair 9 and a timing(s) after the paper P enters the secondary transfer roller pair 9. That is, in the sway control table 124, the sway control information used for the sway control of the registration roller pair 27 before the paper P enters the secondary transfer roller pair 9 and the sway control information used for the sway control of the registration roller pair 27 after the paper P enters the secondary transfer roller pair 9 are stored.

The sway control information to form a toner image(s) at the image's optimum position without generating noise or the like differs depending on the paper conveyance condition, such as the paper type (basis weight, size, paper quality, etc.) of the paper P, the environment (e.g. temperature and humidity), the print side (front side/back side) of the paper P and/or the paper feeding tray. That is, in order to write a toner image(s) at the image's optimum position on the paper P with high accuracy, it is preferable to store, in the sway control table 124, the sway control information for the paper conveyance condition, namely, for each paper type, each environment, each print side and/or each paper feeding tray.

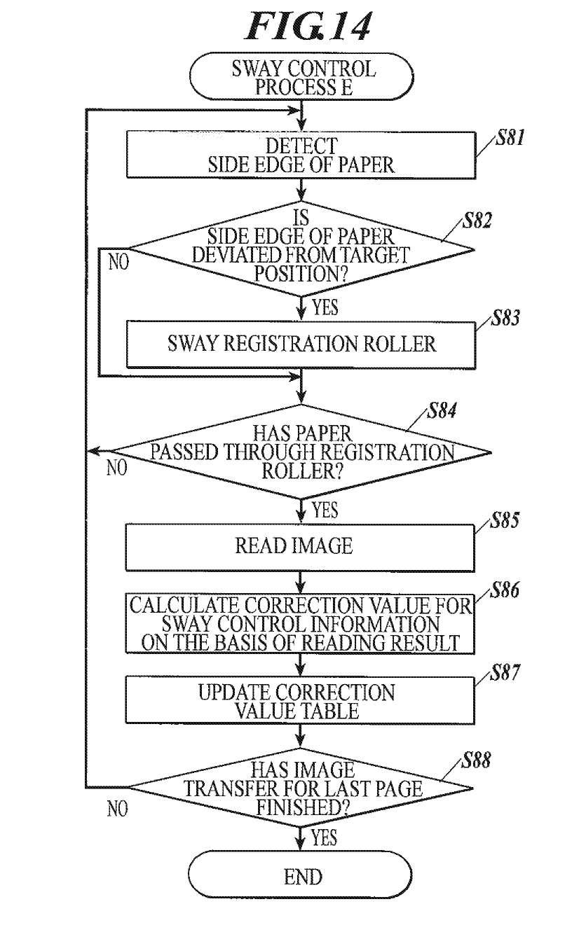

FIG. 13 shows an example of the sway control table 124. FIG. 13 shows, as an example, the sway control table 124 where the sway control information used at each of the sway timings (timings 1 to n) for each paper type is stored.

The correction value table 125 is a table where the correction values to correct the sway control information in the sway control table 124 are stored.

Even if the side edge of the paper P is adjusted to be on the target position Tp, the toner image may not be formed at the image's optimum position because of sub-scanning curving described above. In addition, its deviation amount differs depending on the paper conveyance condition, such as the paper type of the paper P, the environment, the print side and/or the paper feeding tray of the paper P. Hence, in the correction value table 125, the correction values for the (pieces of) sway control information at the respective sway timings in the sway control table 124 for the paper conveyance condition, namely, for each paper type of the paper P, each environment, each print side and/or each paper feeding tray of the paper P, are stored.

In this embodiment, the sway control information (e.g. the target position Tp) used for the sway control of the registration roller pair 27 is information obtained by correcting the sway control information stored in the sway control table 124 with the correction values stored in the correction value table 125.

Except the above, the configuration of the image forming apparatus 100C in the fifth embodiment is the same as that of the image forming apparatus 100B described in the third embodiment, and hence the same reference numbers are given to the same components and the description is not repeated here. Hereinafter, operation of the image forming apparatus 100C in the fifth embodiment is described.

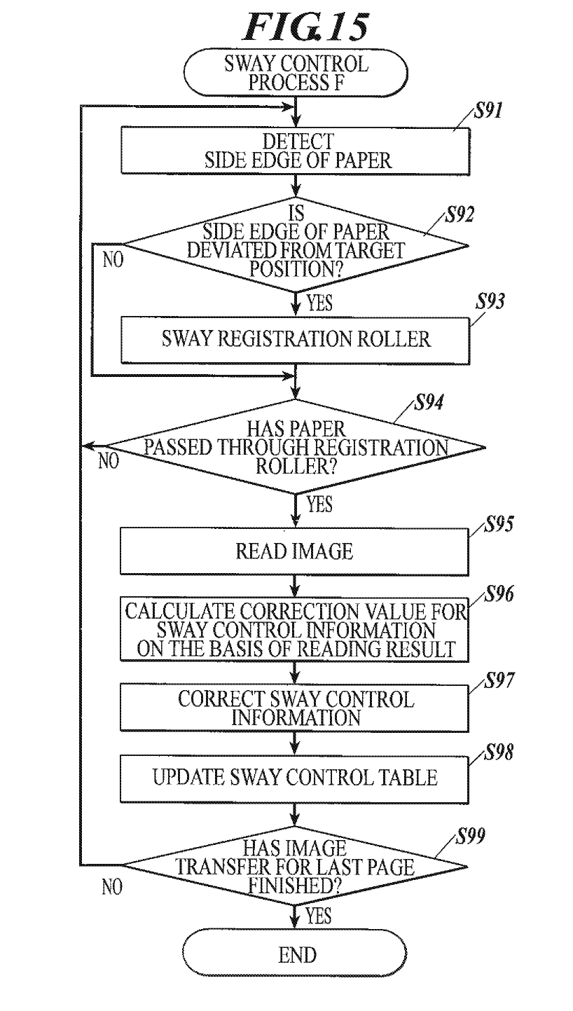

FIG. 14 is a flowchart showing the sway control process E to control the sway of the registration roller pair 27. The process shown in this flowchart is performed by the controller 11 in cooperation with the program stored in the storage 12 in response to a job execution instruction from a user.

When a job is started and the position detection sensor SE3 detects the position of the side edge of (a sheet of) the paper P (Step S81), the controller 11 determines whether or not the side edge of the paper P is deviated from the target position Tp on the basis of (i) the detection result by the position detection sensor SE3 and (ii) the target position Tp identified in the sway control table 124 and the correction value table 125 for the sway timing and the paper conveyance condition (Step S82).

When determining that the side edge of the paper P is not deviated from the target position Tp (Step S82; NO), the controller 11 proceeds to Step S84.

On the other hand, when determining that the side edge of the paper P is deviated from the target position Tp (Step S82; YES), the controller 11 causes the drive mechanism 34 to sway the registration roller pair 27 (Step S83) and proceeds to Step S84. That is, the controller 11 determines the sway amount and the sway direction of the registration roller pair 27 on the basis of the deviation amount of the detected position of the side edge of the paper P from the target position Tp, and causes the drive mechanism 34 to sway the registration roller pair 27 by the determined sway amount in the determined sway direction at the sway speed identified in the sway control table 124 and the correction value table 125 for the sway timing and the paper conveyance condition, and then stop the registration roller pair 27.

In Step S84, the controller 11 determines whether or not the bottom of the paper P has passed through the registration roller pair 27 (Step S84). For example, when a predetermined time for the conveyance speed has elapsed since detection of the bottom of the paper P by the registration sensor SE1, the controller 11 determines that the bottom of the paper P has passed through the registration roller pair 27.

When determining that the bottom of the paper P has not passed through the registration roller pair 27 yet (Step 84; NO), the controller 11 returns to Step S81 and repeats Steps S81 to S84.

In this embodiment, Steps S81 to S84 are repeatedly performed not only before the paper P enters the secondary transfer roller pair 9 like the conventional technology but also after the paper P enters the secondary transfer roller pair 9. Accordingly, the position of the side edge of the paper P is corrected not only at the top of the paper P but also at the bottom of the paper P. Hence, for example, sub-scanning curving significant in the paper that is long in the paper conveying direction, such as long paper, can be corrected.

On the other hand, when determining that the bottom of the paper P has passed through the registration roller pair 27 (Step S84; YES), the controller 11 causes the image reader 60 to read the paper P having a toner image formed by the paper P having passed through the secondary transfer roller pair 9 (Step S85), and calculates the correction values for the sway control information on the basis of the read image obtained by the image reader 60 (Step S86).

In Step S86, for example, the controller 11 identifies the region of the paper P and the region of the toner image from the read image, and obtains the distance between the side edge of the paper P and the toner image at each point in the sub-scanning direction of the paper P corresponding to each sway timing (reference points for the respective sway timings). Then, for example, the controller 11 calculates, as the deviation amount, a difference between (i) each obtained distance and (ii) its ideal distance, namely, distance between the side edge of the paper P and the toner image when the toner image is written at the image's optimum position, and calculates the correction value for the target position Tp at each sway timing on the basis of the calculated deviation amount.

Further, the controller 11 detects noise in the region of the toner image on the basis of the read image obtained by the image reader 60. For example, the controller 11 compares a value(s) of the region of the toner image in the read image with a value(s) of its document image so as to detect noise (image defect). After the paper P enters the secondary transfer roller pair 9, the paper P is swayed by the registration roller pair 27 in the state in which the paper P is sandwiched between and held by the rollers of the secondary transfer roller pair 9. Hence, if the sway speed is too fast, noise due to deviation in transferring or the like is generated. Hence, the controller 11 detects noise in the region of the toner image and calculates the correction value to reduce the sway speed at the sway timing(s) corresponding to a point(s) in the sub-scanning direction, the point(s) where noise is generated.

Then, the controller 11 updates the correction value table 125 with the correction value calculated for each sway timing (Step S87). That is, the controller 11 overwrites the correction values for the respective sway timings and the paper conveyance condition in the correction value table 125 with the calculated correction values, and causes the storage 12 to store the overwritten correction value table 125.

Even if the side edge of the paper P is adjusted to be on the target position Tp at the position of the position detection sensor SE3, sub-scanning curving may occur as described above, and deviation of the toner image position on the paper P tends to be larger one the bottom side of the paper P. In particular, in the paper that is long in the paper conveying direction, such as long paper, the deviation is significant. In this embodiment, the controller 11 calculates the correction values for the (pieces of) sway control information at the multiple points in the sub-scanning direction of the paper P corresponding to the respective sway timings, and the calculated correction values are stored in the correction value table 125. This makes it possible to correct each sway control information on the basis of deviation of the image position and/or noise at each point in the sub-scanning direction, and accordingly can suppress, with high accuracy, deviation of the image position on the paper P caused by sub-scanning curving. Further, because the same side edge of the paper P is adjusted always, influence of variation in the external shape of the paper P can be suppressed.

Next, the controller 11 determines whether or not the image transfer for the last page has finished (Step S88).

When determining that the image transfer for the last page has not finished yet (Step S88; NO), the controller 11 returns to Step S81.

On the other hand, when determining that the image transfer for the last page has finished (Step S88; YES), the controller 11 ends the sway control process E.

The above sway control process E is a process of correcting, on the basis of the sway of the registration roller pair 27, the sway control information to be used for the subsequent sway control(s), the sway control process E being performed during execution of a job. The image forming apparatus 100C, however, has the adjustment mode, and in the adjustment mode, can set the correction values to the correction value table 125 or correct the correction values in the correction value table 125 in advance, namely, before execution of a job. For example, when an instruction for operation in the adjustment mode is input through the operation unit 14, the controller 11 lets a predetermined number of sheets of the paper P be fed from the paper feeding tray 21 or the paper feeding tray of the paper feeding apparatus, causes the image forming units 10Y, 10M, 10C, 10K to form toner images on the basis of image data stored in advance in the storage 12, and causes the secondary transfer roller pair 9 to transfer the toner images onto the sheets of the paper P. The controller 11 also performs the same control as the above sway control process E, and thereby causes the drive mechanism 34 to sway the registration pair 27, causes the image reader 60 to read the sheets of the paper P onto which the toner images have been transferred, calculates the correction values for the sway control information on the basis of the reading results by the image reader 60, and sets the calculated correction values to the correction value table 125 or corrects the correction values in the correction value table 125 with the calculated correction values. Thus, the image forming apparatus 100C has the adjustment mode, and accordingly can set the correction values to the correction value table 125 or correct the correction values in the correction value table 125 in advance, namely, before execution of a job, and hence can suppress deviation of the image position on the paper P starting from the first sheet of the paper P in a job and produce well-finished prints.

### Sixth Embodiment

Next, a sixth embodiment is described.

In the fifth embodiment, the calculated correction values for the sway control information are stored in the correction value table 125, whereas in the sixth embodiment, the sway control information corrected with the calculated correction values is stored in the sway control table 124.

The storage 12 in the sixth embodiment stores a program to perform a sway control process F described below. The storage 12 in the sixth embodiment also stores the sway control table 124 described in the fifth embodiment.

Except the above, the configuration in the sixth embodiment is the same as that described in the fifth embodiment, and hence the description is not repeated here. Hereinafter, operation in the sixth embodiment is described.

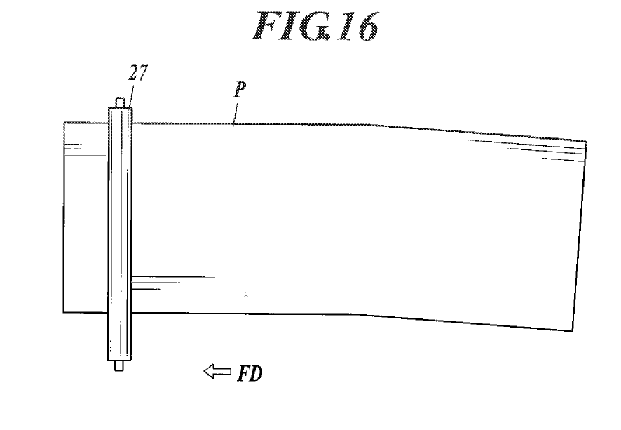

FIG. 15 is a flowchart showing the sway control process F of the registration roller pair 27 that is performed in the sixth embodiment by the controller 11. The process shown in this flowchart is performed by the controller 11 in cooperation with the program stored in the storage 12 in response to a job execution instruction from a user.

When a job is started and the position detection sensor SE3 detects the position of the side edge of (a sheet of) the paper P (Step S91), the controller 11 determines whether or not the side edge of the paper P is deviated from the target position Tp on the basis of (i) the detection result by the position detection sensor SE3 and (ii) the target position Tp identified in the sway control table 124 for the sway timing and the paper conveyance condition (Step S92).

When determining that the side edge of the paper P is not deviated from the target position Tp (Step S92; NO), the controller 11 proceeds to Step S94.

On the other hand, when determining that the side edge of the paper P is deviated from the target position Tp (Step S92; YES), the controller 11 causes the drive mechanism 34 to sway the registration roller pair 27 (Step S93) and proceeds to Step S94. That is, the controller 11 determines the sway amount and the sway direction of the registration roller pair 27 on the basis of the deviation amount of the detected position of the side edge of the paper P from the target position Tp, and causes the drive mechanism 34 to sway the registration roller pair 27 by the determined sway amount in the determined sway direction at the sway speed identified in the sway control table 124 for the sway timing and the paper conveyance condition, and then stop the registration roller pair 27.

In Step S94, the controller 11 determines whether or not the bottom of the paper P has passed through the registration roller pair 27 (Step S94). For example, when a predetermined time for the conveyance speed has elapsed since detection of the bottom of the paper P by the registration sensor SE1, the controller 11 determines that the bottom of the paper P has passed through the registration roller pair 27.

When determining that the bottom of the paper P has not passed through the registration roller pair 27 yet (Step 94; NO), the controller 11 returns to Step S91 and repeats Steps S91 to S94.

In this embodiment, Steps S91 to S94 are repeatedly performed not only before the paper P enters the secondary transfer roller pair 9 like the conventional technology but also after the paper P enters the secondary transfer roller pair 9. Accordingly, the position of the side edge of the paper P is corrected not only at the top of the paper P but also at the bottom of the paper P. Hence, for example, sub-scanning curving significant in the paper that is long in the paper conveying direction, such as long paper, can be corrected.

On the other hand, when determining that the bottom of the paper P has passed through the registration roller pair 27 (Step S94; YES), the controller 11 causes the image reader 60 to read the paper P having a toner image formed by the paper P having passed through the secondary transfer roller pair 9 (Step S95), and calculates the correction values for the sway control information on the basis of the read image obtained by the image reader 60 (Step S96).

In Step S96, for example, the controller 11 identifies the region of the paper P and the region of the toner image from the read image, and calculates the correction value for the sway control information (the target position Tp and the sway speed) at each point in the sub-scanning direction of the paper P corresponding to each sway timing (reference points for the respective sway timings). The correction value calculation method in Step S96 is the same as that in Step S86 in FIG. 14, and hence the description is not repeated here.

Then, the controller 11 corrects the sway control information in the sway control table 124 on the basis of the correction value calculated for each sway timing (Step S97), and updates the sway control table 124 with the corrected sway control information (Step S98). That is, the controller 11 corrects the (pieces of) sway control information for the respective sway timings for the paper conveyance condition in the sway control table 124 with the calculated correction values, and causes the storage 12 to store the corrected sway control table 124.

Even if the side edge of the paper P is adjusted to be on the target position Tp at the position of the position detection sensor SE3, sub-scanning curving may occur as described above, and deviation of the image position on the paper P tends to be larger on the bottom side of the paper P. In particular, in the paper that is long in the paper conveying direction, such as long paper, the deviation is significant. In this embodiment, the controller 11 corrects the (pieces of) sway control information at the multiple points in the sub-scanning direction of the paper P corresponding to the respective sway timings, and the corrected sway control information is stored in the sway control table 124. This makes it possible to correct each sway control information on the basis of deviation of the image position and/or noise at each point in the sub-scanning direction, and accordingly can suppress, with high accuracy, deviation of the image position on the paper P caused by sub-scanning curving. Further, because the same side edge of the paper P is adjusted always, influence of variation in the external shape of the paper P can be suppressed.

Next, the controller 11 determines whether or not the image transfer for the last page has finished (Step S99).

When determining that the image transfer for the last page has not finished yet (Step S99; NO), the controller 11 returns to Step S91.

On the other hand, when determining that the image transfer for the last page has finished (Step S99; YES), the controller 11 ends the sway control process F.

The above sway control process F is a process of correcting, on the basis of the sway of the registration roller pair 27, the sway control information to be used for the subsequent sway control(s), the sway control process F being performed during execution of a job. The image forming apparatus 100C, however, has the adjustment mode, and in the adjustment mode, can set the sway control information to the sway control table 124 or correct the sway control information in the sway control table 124 in advance, namely, before execution of a job. For example, when an instruction for operation in the adjustment mode is input through the operation unit 14, the controller 11 lets a predetermined number of sheets of the paper P be fed from the paper feeding tray 21 or the paper feeding tray of the paper feeding apparatus, causes the image forming units 10Y, 10M, 10C, 10K to form toner images on the basis of image data stored in advance in the storage 12, and causes the secondary transfer roller pair 9 to transfer the toner images onto the sheets of the paper P. The controller 11 also performs the same control as the above sway control process F, and thereby causes the drive mechanism 34 to sway the registration roller pair 27, causes the image reader 60 to read the sheets of the paper P onto which the toner images have been transferred, and sets the sway control information to the sway control table 124 or corrects the sway control information in the sway control table 124 on the basis of the reading results by the image reader 60. Thus, the image forming apparatus 100C has the adjustment mode, and accordingly can set the sway control information to the sway control table 124 or correct the sway control information in the sway control table 124 in advance, namely, before execution of a job, and hence can suppress deviation of the image position on the paper P starting from the first sheet of the paper P in a job and produce well-finished prints.

As described above, according to the image forming apparatus 100C of the fifth and sixth embodiments, the controller 11 performs the sway control to sway the registration roller pair 27 on the basis of the detection result by the position detection sensor SE3 and predetermined sway control information not only before the paper P enters the secondary transfer roller pair 9 but also after the paper P enters the secondary transfer roller pair 9. The controller 11 then causes the image reader 60 to read the paper P onto which an image has been transferred by the paper P having passed through the secondary transfer roller pair 9, and corrects the sway control information on the basis of the reading result.

Thus, the image forming apparatus 100C adjusts the position of the side edge of the paper P even after the paper P enters the secondary transfer roller pair 9, and corrects the sway control information on the basis of deviation of the toner image position on the paper P after the image transfer, and accordingly can suppress, with high accuracy, deviation of the image position on the paper P caused by sub-scanning curving.

Further, for example, the controller 11 corrects, on the basis of the reading result by the image reader 60, the sway control information that is used for the sway control of the registration roller pair 27 before the paper P enters the secondary transfer roller pair 9. This can suppress, with high accuracy, deviation of the image position on the paper P at the top of the paper P caused by sub-scanning curving.

Further, for example, the controller 11 corrects, on the basis of the reading result by the image reader 60, the sway control information that is used for the sway control of the registration roller pair 27 after the paper P enters the secondary transfer roller pair 9. This can suppress, with high accuracy, deviation of the image position on the paper P at the bottom of the paper P caused by sub-scanning curving.

Further, for example, the controller 11 determines the correction value for the sway control information on the basis of the reading result by the image reader 60, and causes the storage 12 to store the determined correction value. This allows the correction value to be used for the next job(s) and even after power of the image forming apparatus 100C is turned off. Further, for example, the controller 11 causes the storage 12 to store the table for the paper conveyance condition, such as the paper type, the environment, the print side and/or the paper feeding tray, the table where the correction value for the sway control information is stored. This enables the optimum sway control for the paper conveyance condition.

Further, for example, the controller 11 causes the storage 12 to store the table for the paper conveyance condition, such as the paper type, the environment, the print side and/or the paper feeding tray, the table where the sway control information is stored, and corrects the sway control information for the paper conveyance condition stored in the table with the correction value determined on the basis of the reading result by the image reader 60. This enables the optimum sway control for the paper conveyance condition.

Further, the image forming apparatus 100C has the adjustment mode, and in response to an instruction for operation in the adjustment mode, operates in the adjustment mode of automatically feeding the paper P, transferring an image onto the paper P, reading the paper P with the image reader 60, and correcting the sway control table 124 or the correction value table 125 on the basis of the reading result. This makes it possible to set the optimum sway control information and/or correction value in advance, namely, before execution of a job.

Further, the controller 11 corrects the sway control information for each of the sway timings of the registration roller pair 27 on the basis of the reading result by the image reader 60. This can suppress, with higher accuracy, deviation of the image position on the paper P caused by sub-scanning curving.

Although the first to sixth embodiments are described above, the matters described in these embodiments are merely some of preferred examples of the image forming apparatus of the present invention, and not intended to limit the present invention.

For example, in the first to sixth embodiments, each time an image for one page is transferred onto the paper P, the image reader 60 reads the paper P, and the controller 11 corrects the sway control information on the basis of the reading result in real time. Alternatively, the controller 11 may correct the sway control information on the basis of an arithmetic value of the reading results (e.g. the mean of deviation amounts, the median thereof, etc.) for a predetermined period (i.e. of a plurality of sheets onto which images have been transferred). This makes it possible to efficiently correct the sway control information on the basis of a trend during the predetermined period.

Further, in the sway control processes A to F, during execution of a job, the controller 11 corrects, on the basis of the reading result of one sheet of the paper P by the image reader 60, the sway control information that is used for the sway control of the registration roller pair 27 for the next sheet. Alternatively, the controller 11 may correct the sway control information that is used for the sway control of the registration roller pair 27 for the bottom side of the one sheet itself of the paper P. For example, in the case of the paper that is long in the paper conveying direction, such as long paper (i.e. long sheets), when the image reader 60 reads a predetermined size of a sheet from the top of the sheet, the controller 11 may calculate the correction value for the sway control information on the basis of the reading result, correct the sway control information with the calculated correction value, and control the registration roller pair 27 for the bottom side of the sheet itself on the basis of the corrected sway control information.

Further, in the first to sixth embodiments, the controller 11 performs the control to sway the registration roller pair 27 on the basis of the sway control information corrected on the basis of the reading result by the image reader 60. This is not intended to limit the present invention. For example, the controller 11 may perform control to correct the position where images are written (hereinafter “image writing position”) by the image forming units 10Y, 10M, 10C, 10K in addition to the control to sway the registration roller pair 27.

For example, the controller 11 may perform the control to correct the image writing position of the image forming units 10Y, 10M, 10C, 10K, thereby correcting the absolute position of an image to the paper P, and thereafter perform the control to sway the registration roller pair 27, thereby reducing variation in the position of the side edge of the paper P. If the variation in the position of the side edge of the paper P is small enough, the controller 11 may not perform the control to sway the registration roller pair 27.

Further, the controller 11 may determine on the basis of the reading result by the image reader 60 whether or not to perform at least one of the sway control of the registration roller pair 27 and the correction control of the image writing position of the image forming units 10Y, 10M, 10K, 10C. This can suppress, with higher accuracy, deviation of the image position on the paper P caused by sub-scanning curving.

Further, in the first to sixth embodiments, the image forming apparatus is a color image forming apparatus that primary-transfers images formed on photoconductive drums to an intermediate transfer belt, and secondary-transfers the images from the intermediate transfer belt to paper by a secondary transfer roller pair. The present invention is also applicable to a monochrome image forming apparatus that directly transfers images from a photoconductive drum to paper by a transfer roller pair.

Further, in the first and second embodiments, the controller 11 performs the sway control of the registration roller pair 27 on the basis of the reading result of the paper P onto which an image(s) has been transferred, the reading result being obtained by the image reader 60. Alternatively, a position detection sensor may be provided between the registration roller pair 27 and the secondary transfer roller pair 9, and the controller 11 may control the sway of the registration roller pair 27 on the basis of the detection result of the side edge of the paper P by the position detection sensor.

Further, in the first to sixth embodiments, the registration roller pair 27 is the sway roller pair. This is not intended to limit the present invention. For example, the sway roller pair may be provided separately from the registration roller pair 27.

Further, in the first to sixth embodiments, the registration roller pair 27 sways in the paper width direction CD (direction orthogonal to the paper conveying direction). This is not intended to limit the present invention. What is needed here is changing the direction to send/convey the paper P. That is, as far as the paper P being conveyed can be made to move along the paper width direction CD, the registration roller pair 27 may sway in a direction other than the paper width direction CD (e.g. a direction deviated five degrees from the paper width direction CD).

Further, in the third to sixth embodiments, the position detection sensor SE3 is provided between the registration roller pair 27 and the secondary transfer roller pair 9, and the controller 11 controls the sway of the registration roller pair 27 on the basis of the detection result of the side edge of the paper P by the position detection sensor SE3. Alternatively, the controller 11 may perform the sway control of the registration roller pair 27 on the basis of the reading result of the paper P onto which an image(s) has been transferred, the reading result being obtained by the image reader 60, without the position detection sensor SE3.

Further, in the third and fourth embodiments, before the paper P enters the secondary transfer roller pair 9, the controller 11 makes the registration roller pair 27 sway on the basis of the detection result by the position detection sensor SE3 and the sway control information. This is not intended to limit the present invention. For example, the controller 11 may perform, before the paper P enters the secondary transfer roller pair 9, the same sway control as the one which the controller 11 performs after the paper P enters the secondary transfer roller pair 9.

Further, in the fifth and sixth embodiments, the controller 11 makes the registration roller pair 27 sway on the basis of the detection result by the position detection sensor SE3 and the sway control information before and after the paper P enters the secondary transfer roller pair 9. Alternatively, the controller 11 may perform different sway control before the paper P enters the secondary transfer roller pair 9.

Further, in the sway control processes E and F, the controller 11 performs the control to sway the registration roller pair 27 until the paper P comes out of the registration roller pair 27 if the position of the side edge of the paper P is deviated from the target position Tp. Alternatively, it is possible that multiple timings at which the controller 11 performs the sway control (to detect the side edge of the paper P with the position detection sensor SE3 and sway the registration roller pair 27) are determined in advance according to the length of the paper P, and the controller 11 performs the sway control multiple times at the predetermined multiple timings.

Further, in the above, as a computer readable medium for the programs of the present invention, a nonvolatile memory, a hard disk or the like is used. This is not intended to limit the present invention. The computer readable medium may be a portable recording/storage medium, such as a CD-ROM. Further, as a medium to provide data of the programs of the invention, a carrier wave can be used.

In addition to the above, the specific configurations/components and the specific operations of the image forming apparatus can also be appropriately modified without departing from the scope of the present invention.

Although several embodiments of the present invention have been described and illustrated in detail, the disclosed embodiments are made for purposes of illustration and example only and not limitation. The scope of the present invention should be interpreted by terms of the appended claims

The entire disclosure of Japanese Patent Applications No. 2017-107579, No. 2017-107586 and No. 2017-107626 all filed on May 31, 2017 is incorporated herein by reference in its entirety.

What is claimed is:

1. An image forming apparatus comprising:
a transfer unit that transfers an image onto paper being conveyed to an image transfer position where the transfer unit transfers the image onto the paper;
a sway roller pair constituted of a pair of rollers that conveys the paper to the transfer unit, the paper being conveyed to the sway roller pair;
a hardware processor that makes the sway roller pair sway based on predetermined sway control information; and
an image reader that reads the paper onto which the image has been transferred by the paper having passed through the transfer unit, wherein
the hardware processor corrects the sway control information based on a reading result of the reading performed by the image reader.

2. The image forming apparatus according to claim 1, wherein the hardware processor makes the sway roller pair sway based on the corrected sway control information, thereby controlling a position of a side edge of the paper.

3. The image forming apparatus according to claim 1, wherein the hardware processor corrects, based on the reading result by the image reader, the sway control information that is used for sway control of the sway roller pair before the paper enters the transfer unit and after the paper enters the transfer unit.

4. The image forming apparatus according to claim 1, further comprising a storage, wherein
the hardware processor determines a correction value for the sway control information based on the reading result by the image reader, and causes the storage to store the determined correction value.

5. The image forming apparatus according to claim 4, wherein the storage stores, for a paper conveyance condition, a table where the correction value for the sway control information is stored.

6. The image forming apparatus according to claim 1, further comprising a storage that stores, for a paper conveyance condition, a table where the sway control information is stored, wherein
the hardware processor determines a correction value for the sway control information based on the reading result by the image reader, and corrects, with the determined correction value, the sway control information stored in the table.

7. The image forming apparatus according to claim 5, further comprising an adjustment mode of:
feeding the paper; transferring the image onto the paper; reading, with the image reader, the paper onto which the image has been transferred; and setting or correcting the table based on the reading result.

8. The image forming apparatus according to claim 1, wherein each time the image reader performs the reading, the hardware processor corrects the sway control information based on the reading result in real time.

9. The image forming apparatus according to claim 1, wherein the hardware processor corrects the sway control information based on an arithmetic value of the reading result for a predetermined period by the image reader.

10. The image forming apparatus according to claim 1, wherein the hardware processor: makes, at each of predetermined multiple timings, the sway roller pair sway based on the sway control information; and corrects, for each of the predetermined multiple timings, the sway control information based on the reading result by the image reader.

11. The image forming apparatus according to claim 1, wherein the hardware processor determines based on the reading result by the image reader whether or not to perform at least one of sway control of the sway roller pair and correction control of an image writing position of an image writer.

12. The image forming apparatus according to claim 1, wherein the sway roller pair sways in a direction orthogonal to a conveying direction of the paper.

13. The image forming apparatus according to claim 1, further comprising a sensor that is provided between the sway roller pair and the transfer unit and detects a position of a side edge of the paper, wherein
the hardware processor performs sway control of the sway roller pair before the paper enters the transfer unit and after the paper enters the transfer unit, and at least after the paper enters the transfer unit, makes the sway roller pair sway based on the predetermined sway control information and makes the sway roller pair stop swaying based on a detection result of the detection performed by the sensor.

14. The image forming apparatus according to claim 1, further comprising a sensor that is provided between the sway roller pair and the transfer unit and detects a position of a side edge of the paper, wherein
the hardware processor performs sway control of the sway roller pair before the paper enters the transfer unit and after the paper enters the transfer unit, and at least after the paper enters the transfer unit, makes the sway roller pair sway based on a detection result of the detection performed by the sensor and the predetermined sway control information.

15. A sway roller control method for an image forming apparatus including a sway roller pair constituted of a pair of rollers that conveys, to a transfer unit, paper being conveyed to the sway roller pair, comprising:
making the sway roller pair sway based on predetermined sway control information;
causing an image reader to read the paper onto which an image has been transferred by the paper having passed through the transfer unit; and
correcting the sway control information based on a reading result of the reading performed by the image reader.
